(19) United States
(12) Patent Application Publication
(10) Pub. No.: US 2018/0203214 A1
(43) Pub. Date: Jul. 19, 2018

(54) ZOOM LENS, AND IMAGE PICKUP APPARATUS

(71) Applicant: CANON KABUSHIKI KAISHA, Tokyo (JP)

(72) Inventor: Masaru Sakamoto, Utsunomiya-shi (JP)

(21) Appl. No.: 15/874,048

(22) Filed: Jan. 18, 2018

(30) Foreign Application Priority Data
Jan. 19, 2017 (JP) 2017-007596

(51) Int. Cl. G02B 15/16

(52) U.S. Cl. CPC G02B 15/16

(57) ABSTRACT

A zoom lens including in order from an object side: a positive first unit configured not to move for zooming; a negative second unit configured to move to the image side for zooming to a telephoto end; and a relay lens unit configured not to move for zooming, wherein the first unit consists of five lenses including, in order from the object side, a negative lens, a positive lens, a positive lens, a positive lens and a positive lens, or six lenses including, in order from the object side, a positive lens, a negative lens, a positive lens, a positive lens, a positive lens and a positive lens, and a refractive index of the negative lens in the first unit, an Abbe number of the negative lens, a focal length of the negative lens, and a focal length of the first lens unit are appropriately set.

### BACKGROUND OF THE INVENTION

### Field of the Invention

The present invention relates to a zoom lens, and an image pickup apparatus.

### Description of the Related Art

In recent years, an image pickup apparatus such as a television camera, a silver halide film camera, a digital camera and a video camera has been desired to be provided with a zoom lens which has a wide angle of view, a high zoom ratio, and a high optical performance besides. As for the zoom lens having a large aperture ratio, the wide angle of view and the high zoom ratio, a positive-lead type of zoom lens is known which has a lens unit having a positive refractive power arranged closest to the object side, and makes a part of a first unit adjust the focus. In addition, as for a zooming method, a zoom lens is known which includes in order from an object side, a first lens unit that has a positive refractive power and is fixed during zooming, a second lens unit that has a negative refractive power and moves for zooming, and a lens unit for imaging, which is fixed during zooming in the side closest to the image plane.

Japanese Patent Application Laid-Open No. 2011-81063 proposes a high magnification zoom lens that has a zoom ratio of approximately 40 and an angle of view of approximately 27 degrees at a wide angle end.

In the above described positive lead type zoom lens, in order to achieve both high magnification and high optical performance at the telephoto side while keeping miniaturization and the widening of the angle of view, it becomes important to appropriately set the configuration, the refractive power and the focusing method of the first lens unit. Unless these configurations are appropriately set, it becomes difficult to obtain a zoom lens which has the wide angle of view, the high magnification and the high optical performance at the telephoto end.

In the zoom lens disclosed in Japanese Patent Application Laid-Open No. 2011-81063, an axial chromatic aberration during zooming and various aberrations in the periphery of the telephoto end have tended to increase along with an increase of magnification.

### SUMMARY OF THE INVENTION

The present invention provides, for example, a zoom lens advantageous in a wide angle of view, a high zoom ratio, and a high optical performance at a telephoto end thereof.

The present invention provides a zoom lens that includes in order from an object side to an image side: a first lens unit having a positive refractive power and configured not to move for zooming; a second lens unit having a negative refractive power and configured to move to the image side for zooming from a wide angle end to a telephoto end; and a relay lens unit configured not to move for zooming, wherein the first lens unit consists of five lenses including, in order from the object side to the image side, a negative lens, a positive lens, a positive lens, a positive lens and a positive lens, or six lenses including, in order from the object side to the image side, a positive lens, a negative lens, a positive lens, a positive lens, a positive lens and a positive lens, and conditional expressions

39<νn<48 (1),

2.24<Nn+0.01×νn<2.32 (2),

1.79<Nn<1.91 (3), and

1.5<|fn/f1|<2.0 (4)

are satisfied, where Nn represents a refractive index of the negative lens in the first lens unit, νn represents an Abbe number of the negative lens, fn represents a focal length of the negative lens, and f1 represents a focal length of the first lens unit, the Abbe number ν being expressed by an expression

ν=(Nd−1)/(NF−NC)

where NF, Nd and NC represent refractive indices with respect to an F-line, a d-line and a C-line of Fraunhofer lines, respectively.

Further features of the present invention will become apparent from the following description of exemplary embodiments with reference to the attached drawings.

### BRIEF DESCRIPTION OF THE DRAWINGS

FIG. 1 is a sectional view of lenses at the time when a zoom lens in Numerical Embodiment 1 focuses on an infinite object at a wide angle end.

FIG. 2A is an aberration diagram at the time when the zoom lens in Numerical Embodiment 1 focuses on an infinite object at a wide angle end.

FIG. 2B is an aberration diagram at the time when the zoom lens in Numerical Embodiment 1 focuses on an infinite object at a telephoto end.

FIG. 3 is a sectional view of lenses at the time when a zoom lens in Numerical Embodiment 2 focuses on an infinite object at a wide angle end.

FIG. 4A is an aberration diagram at the time when the zoom lens in Numerical Embodiment 2 focuses on an infinite object at a wide angle end.

FIG. 4B is an aberration diagram at the time when the zoom lens in Numerical Embodiment 2 focuses on an infinite object at a telephoto end.

FIG. 5 is a sectional view of lenses at the time when a zoom lens in Numerical Embodiment 3 focuses on an infinite object at a wide angle end.

FIG. 6A is an aberration diagram at the time when the zoom lens in Numerical Embodiment 3 focuses on an infinite object at a wide angle end.

FIG. 6B is an aberration diagram at the time when the zoom lens in Numerical Embodiment 3 focuses on an infinite object at a telephoto end.

FIG. 7 is a sectional view of lenses at the time when a zoom lens in Numerical Embodiment 4 focuses on an infinite object at a wide angle end.

FIG. 8A is an aberration diagram at the time when the zoom lens in Numerical Embodiment 4 focuses on an infinite object at a wide angle end.

FIG. 8B is an aberration diagram at the time when the zoom lens in Numerical Embodiment 4 focuses on an infinite object at a telephoto end.

FIG. 9 is a sectional view of lenses at the time when a zoom lens in Numerical Embodiment 5 focuses on an infinite object at a wide angle end.

FIG. 10A is an aberration diagram at the time when the zoom lens in Numerical Embodiment 5 focuses on an infinite object at a wide angle end.

FIG. 10B is an aberration diagram at the time when the zoom lens in Numerical Embodiment 5 focuses on an infinite object at a telephoto end.

FIG. 11 is a sectional view of lenses at the time when a zoom lens in Numerical Embodiment 6 focuses on an infinite object at a wide angle end.

FIG. 12A is an aberration diagram at the time when the zoom lens in Numerical Embodiment 6 focuses on an infinite object at a wide angle end.

FIG. 12B is an aberration diagram at the time when the zoom lens in Numerical Embodiment 6 focuses on an infinite object at a telephoto end.

FIG. 13 is a sectional view of lenses at the time when a zoom lens in Numerical Embodiment 7 focuses on an infinite object at a wide angle end.

FIG. 14A is an aberration diagram at the time when the zoom lens in Numerical Embodiment 7 focuses on an infinite object at a wide angle end.

FIG. 14B is an aberration diagram at the time when the zoom lens in Numerical Embodiment 7 focuses on an infinite object at a telephoto end.

FIG. 15 is a view for describing an embodiment of an image pickup apparatus of the present invention.

### DESCRIPTION OF THE EMBODIMENTS

Preferred embodiments of the present invention will now be described in detail in accordance with the accompanying drawings.

A zoom lens of the present invention includes in order from an object side to an image side: a positive first lens unit that does not move for zooming and moves for focusing; a negative second lens unit that moves to an image side for zooming from a wide angle end to a telephoto end; and a relay lens unit that is arranged closest to the image side and does not move for zooming.

The first lens unit includes in order from an object side to an image side, five lenses of negative, positive, positive, positive and positive lenses, or includes in order from the object side to the image side, six lenses of positive, negative, positive, positive, positive and positive lenses.

When a refractive index of the negative lens of the first lens unit is represented by Nn, the Abbe number is represented by νn, a focal length is represented by fn, and a focal length of the first lens unit is represented by f1, the zoom lens satisfies the following conditional expressions:

39<νn<48 (1),

2.24<Nn+0.01×νn<2.32 (2),

1.79<Nn<1.91 (3), and

1.5<|fn/f1|<2.0 (4)

The Conditional Expressions (1), (2) and (3) specify the characteristics of the optical glass of the negative lenses in the first lens unit. Usually, the optical glass contains many types of metal oxides. The metal oxides include, for instance, SiO₂, TiO₂, La₂O₃, Al₂O₃, Nb₂O₅, ZrO₂ and Gd₂O₃. Among them, TiO₂, for instance, has an effect of enhancing the refractive index and reducing the Abbe number, and the glass containing a lot of TiO₂ has characteristics of comparatively high refractive index and high dispersion. In addition, Gd₂O₃ has an effect of enhancing the refractive index and increasing the Abbe number, and the glass containing a lot of Gd₂O₃ is known to have comparatively a high refractive index and low dispersion. TiO₂ and Gd₂O₃ respectively have the high refractive index and high dispersion and the high refractive index and low dispersion, originally, and characteristics of the glass containing the above substances result in approaching to the characteristics of the original metal oxides.

Thus, the optical glass has such properties that the characteristics vary depending on the amount of the component which the optical glass contains, and an optical glass having desired optical characteristics is obtained by appropriately setting the amounts of the components. This is similar in the optical ceramics, and for instance, optical ceramics containing a lot of substance having high refractive index and low dispersion result in having comparatively high refractive index and low dispersion.

As for substances having the high refractive index and low dispersion, there are, for instance, Gd₂O₃, Al₂O₃ and Lu₃Al₅O₁₂. By appropriately setting the amounts of these substances and metal oxides such as SiO₂, TiO₂ and La₂O₃, and dissolving or sintering the substances in each other, optical materials such as optical glass and ceramics having desired optical characteristics (refractive index and Abbe number) can be obtained.

In addition, in the zoom lens having the above described zoom configuration, as the focal length approaches the telephoto side, the height of an on-axis light beam of the first lens unit increases in proportion to the focal length. As the height of this axial ray becomes high, the chromatic aberration occurring in the first lens unit is further enlarged, which leads to the deterioration of performance.

Here, when the amount of chromatic aberration of the first lens unit is represented by Δ1 and the imaging magnification of lenses after the first lens unit is represented by βr, the amount Δ of the chromatic aberration in the whole lens system is expressed by the following expression:

Δ=Δ1×βr²+α

where α represents a contribution to the chromatic aberration Δ of units other than the first lens unit. The Δ remarkably occurs in the first lens unit in which the axial marginal ray passes through a high position at the telephoto side. Accordingly, the axial chromatic aberration quantity Δ on the telephoto side can be reduced by suppressing the secondary spectral quantity Δ1 of the axial chromatic aberration which occurs in the first lens unit.

Conditional Expression (1) specifies the condition of the Abbe number of the negative lens which constitutes the first lens unit. If the Abbe number exceeds the lower limit of Conditional Expression (1), the dispersions (Abbe number νd) of the positive lens and the negative lens approach each other within an appropriate range, and the dispersion characteristics (partial dispersion ratio θgf) of the positive lens and the negative lens can be brought closer to each other because of the selection of the glass material, so that the secondary spectral quantity Δ1 of the axial chromatic aberration can be suppressed which is generated in the first lens unit. If the Abbe number exceeds the upper limit of Conditional Expression (1), the refractive power of each of the single lenses in the first lens unit becomes large, and it becomes difficult to correct various aberrations at the telephoto end, particularly, a spherical aberration and comatic aberration. In addition, it becomes difficult to produce a glass material having the low dispersion and high refractive index.

Conditional Expression (1) can be set further as follows.

40<νn<44 (1a)

Conditional Expression (2) specifies a relational expression between the Abbe number and the refractive index of the negative lens which constitutes the first lens unit.

If the value of the relational expression does not satisfy the lower limit of Conditional Expression (2), the glass of the negative lens becomes not to have the high refractive index and low dispersion, which accordingly makes it difficult to adequately correct the chromatic aberration at the telephoto end. If the value of the relational expression exceeds the upper limit of Conditional Expression (2), it becomes difficult to produce a glass material having the low dispersion and high refractive index.

Conditional Expression (2) can be set further as follows.

2.25<Nn+0.01×νn<2.30 (2a)

Conditional Expression (3) specifies the condition of the refractive index of the negative lens which constitutes the first lens unit. If the refractive index does not satisfy the lower limit of Conditional Expression (3), the curvature of the negative lens increases, which accordingly makes it difficult to correct various aberrations at the telephoto end, particularly, the spherical aberration and the comatic aberration. If the refractive index exceeds the upper limit of Conditional Expression (3), it becomes difficult to produce a glass material having the low dispersion and high refractive index.

Conditional Expression (3) can be set further as follows.

1.80<Nn<1.89 (3a)

The Conditional Expression (4) specifies a ratio of the refractive power of the first lens unit to the refractive power of the negative lens which constitutes the first lens unit.

If the ratio does not satisfy the upper limit and the lower limit of the Conditional Expression (4), it becomes difficult to appropriately correct the occurrence of chromatic aberration of the negative lens which constitutes the first lens unit, by the positive lens, and it becomes difficult to correct the axial chromatic aberration and a chromatic aberration of magnification at the telephoto end.

Conditional Expression (4) can be set further as follows.

1.51<|fn/f1|<1.9 (4a)

In a further embodiment of the present invention, the average value νpa of the dispersions of the positive lenses in the first lens unit is specified by Conditional Expression (5).

77<νpa<100 (5)

If the average value νpa is below the lower limit value of Conditional Expression (5), the refractive power of each of the single lenses in the first lens unit becomes large, and it becomes difficult to correct various aberrations at the telephoto end, particularly, the spherical aberration and the comatic aberration.

If the average value νpa is over the upper limit value of Conditional Expression (5), it becomes difficult to produce a low-dispersion glass material. Conditional Expression (5) can be set further as follows.

82<νpa<96 (5a)

In a further embodiment of the present invention, a condition is specified for obtaining a zoom lens that has the high magnification, the wide angle of view, and the high optical performance over the whole zoom range, by specifying the configurations and the refractive powers of the lens units after the third lens unit. By adopting the configuration of Conditional Expression (5), the high magnification can be achieved while the total lens length is kept.

In a further embodiment of the present invention, the condition of the dispersion characteristics of the lens material in the second lens unit is specified by Conditional Expression (6). When the Abbe number and the partial dispersion ratio of the positive lens having the smallest Abbe number out of the positive lenses which constitute the second lens unit are represented by νp2 and θp2, respectively, and the Abbe number and the partial dispersion ratio of the negative lens having the smallest Abbe number out of the negative lenses which constitute the second lens unit are represented by νn2 and θn2, respectively, the positive lens and the negative lens satisfy the following conditional expression of

3.1×10⁻³<(θp2−θn2)/(νn2−νp2)<6.0×10⁻³ (6).

If the value of (θp2−θn2)/(νn2−νp2) does not satisfy the lower limit of Conditional Expression (6), the effect for correcting the occurrence of chromatic aberration of the first lens unit by the second lens unit becomes insufficient, and it becomes difficult to adequately correct a fluctuation of the axial chromatic aberration due to zooming. If the value of (θp2−θn2)/(vn2−vp2) is over the upper limit of Conditional Expression (6), it becomes difficult to adequately correct the fluctuation of the chromatic aberration of magnification due to the chromatic aberration which is generated by the second lens unit. In addition, because the selection of the glass material is limited, the dispersions of the positive lens and the negative lens in the second lens unit become close to each other, and the refractive power of each of the single lenses increases. As a result, it becomes difficult to adequately correct various aberrations at the telephoto end.

Conditional Expression (6) can be set further as follows.

3.4×10⁻³<(θp2−θn2)/(νn2−νp2)<5.6×10⁻³ (6a)

In a further embodiment of the present invention, a ratio between the focal lengths f1 and f2 of the first lens unit and the second lens unit is specified by Conditional Expression (7).

3<|f1/f2|<9 (7)

If the ratio is over the upper limit of Conditional Expression (7), the refractive power of the second lens unit becomes too strong relatively to the refractive power of the first lens unit, the fluctuation of various aberrations increases, which makes it difficult to correct the various aberrations.

If the ratio is below the lower limit of Conditional Expression (7), the refractive power of the second lens unit becomes too weak relatively to the refractive power of the first lens unit, the amount of movement of the second lens unit for zooming increases, which makes it difficult to achieve both of the miniaturization and the high magnification.

Next, the features of each numerical embodiment will be described below.

### Embodiment 1

The zoom lens of the Numerical Embodiment 1 of the present invention includes in order from an object side to an image side: a positive first lens unit that does not move for zooming and moves for focusing; a negative second lens unit that moves to an image side for zooming from the wide angle end to the telephoto end; a negative third lens unit that moves for zooming; and a positive relay lens unit for imaging, which does not move for zooming.

The first lens unit includes in order from the object side to the image side, five lenses of negative, positive, positive, positive and positive lenses.

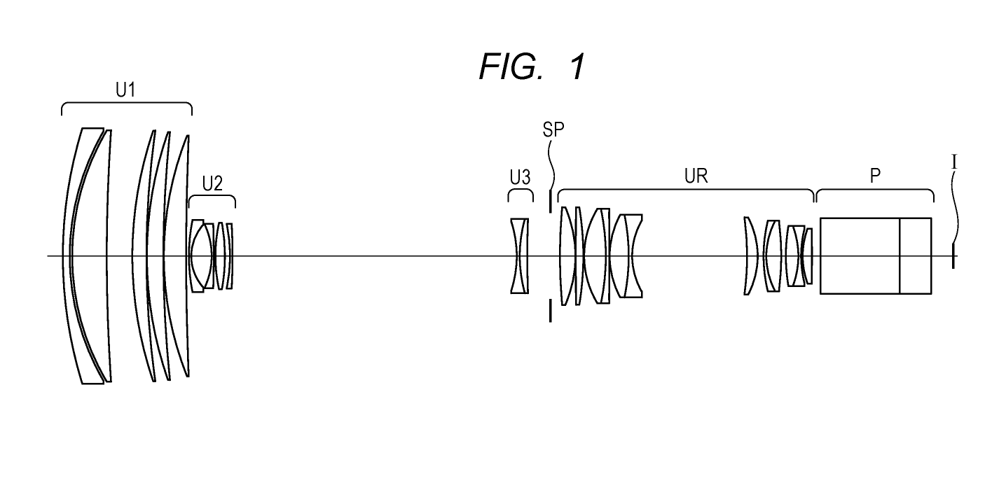

FIG. 1 is a sectional view of lenses at the time when the zoom lens in Numerical Embodiment 1 of the present invention focuses on an infinite object at the wide angle end. In the sectional view of the lenses, the left side is a subject side (object side), and the right side is an image side.

The first lens unit U1 has a positive refractive power and does not move for zooming. A part of the first lens unit moves from the image side to the object side for focus adjustment from the infinite distance to a finite distance. The second lens unit (variator lens unit) U2 has a negative refractive power for zooming and moves to the image side for zooming from the wide angle end (short focal length end) to the telephoto end (long focal length end). The third lens unit U3 has a negative refractive power and moves for zooming. An aperture stop SP is illustrated. A relay lens unit UR does not move for zooming. The reference character P corresponds to an optical filter or a color separation optical system, and is illustrated as a glass block in the figure. An image plane I corresponds to an imaging plane of the image pickup element (photoelectric conversion element).

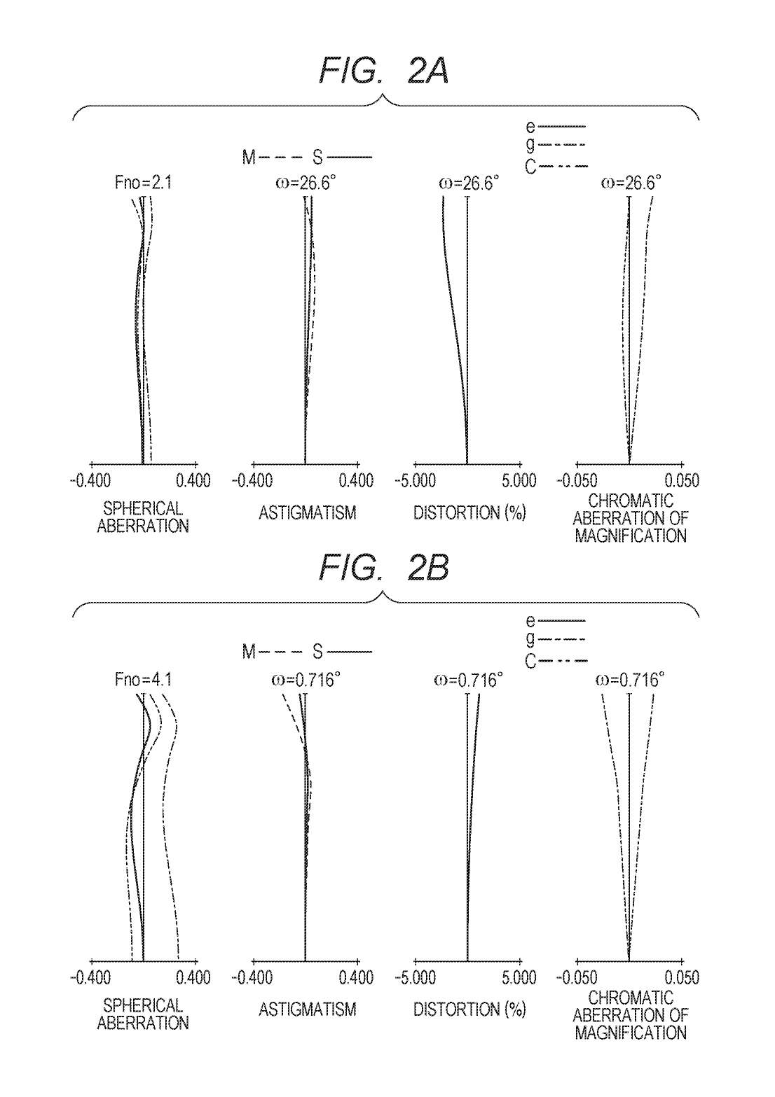

FIGS. 2A and 2B illustrate aberration diagrams at the time when the zoom lens in Numerical Embodiment 1 focuses on the infinite object at the wide angle end and the telephoto end, respectively. In each of the aberration diagrams, the spherical aberration is shown by e-line, g-line, and C-line. The astigmatism is shown by a meridional image plane (M) for the e-line and a sagittal image plane (S) for the e-line. The distortion is shown for the e-line, and the chromatic aberration of magnification is shown for the g-line and the C-line. In addition, the spherical aberration is drawn with a scale of 0.4 mm, the astigmatism with a scale of 0.4 mm, the distortion with a scale of 5%, and the chromatic aberration of magnification with a scale of 0.05 mm. The F number Fno is illustrated, and the half angle of view ω is illustrated. Incidentally, the wide angle end and the telephoto end mean the zoom positions at the time when the zoom lens is positioned in both ends of the range in which the second lens unit U2 (variator lens unit) for zooming can move on the optical axis by the mechanism, respectively. The above description is similar in the following Numerical Embodiments 2 to 7.

Table 1 shows values corresponding to each of the conditional expressions in Numerical Embodiment 1. Numerical Embodiment 1 satisfies Conditional Expressions (1) to (7). Thereby, the zoom lens of the present invention achieves a small-sized and lightweight imaging optical system having the high zoom ratio, the wide angle of view, and the high optical performance at the telephoto end.

### Embodiment 2

A zoom lens of the Numerical Embodiment 2 of the present invention includes in order from the object side to the image side: a positive first lens unit that does not move for zooming and moves for focusing; a negative second lens unit that moves to the image side for zooming from the wide angle end to the telephoto end; a negative third lens unit that moves for zooming; a negative fourth lens unit that moves for zooming; and a positive relay lens unit that does not move for zooming.

The first lens unit includes in order from the object side to the image side, five lenses of negative, positive, positive, positive and positive lenses.

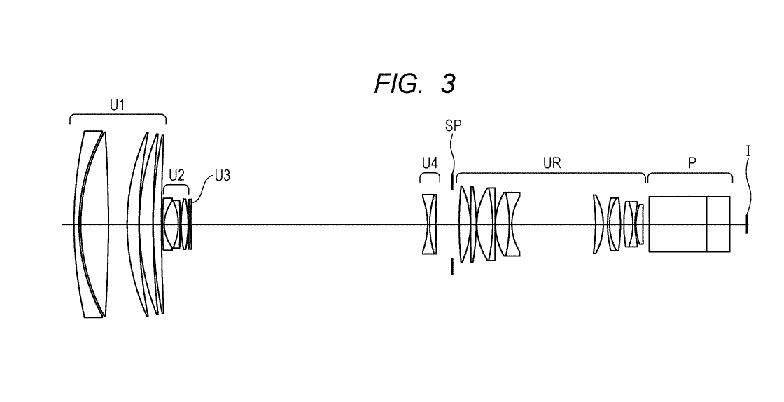

FIG. 3 is a sectional view of lenses at the time when the zoom lens in Numerical Embodiment 2 of the present invention focuses on an infinite object at a wide angle end. The first lens unit U1 has a positive refractive power and does not move for zooming. A part of the first lens unit moves from the image side to the object side for the focus adjustment from the infinite distance to a finite distance. A second lens unit (variator lens unit) U2 has a negative refractive power for zooming and moves to the image side for zooming from the wide angle end to the telephoto end. A third lens unit U3 has a negative refractive power and moves for zooming. A fourth lens unit U4 has a negative refractive power and moves for zooming. The aperture stop SP is illustrated. The relay lens unit UR has a positive refractive power and does not move for zooming. The reference character P corresponds to an optical filter or a color separation optical system, and is illustrated as a glass block in the figure. An image plane I corresponds to the imaging plane of the image pickup element (photoelectric conversion element).

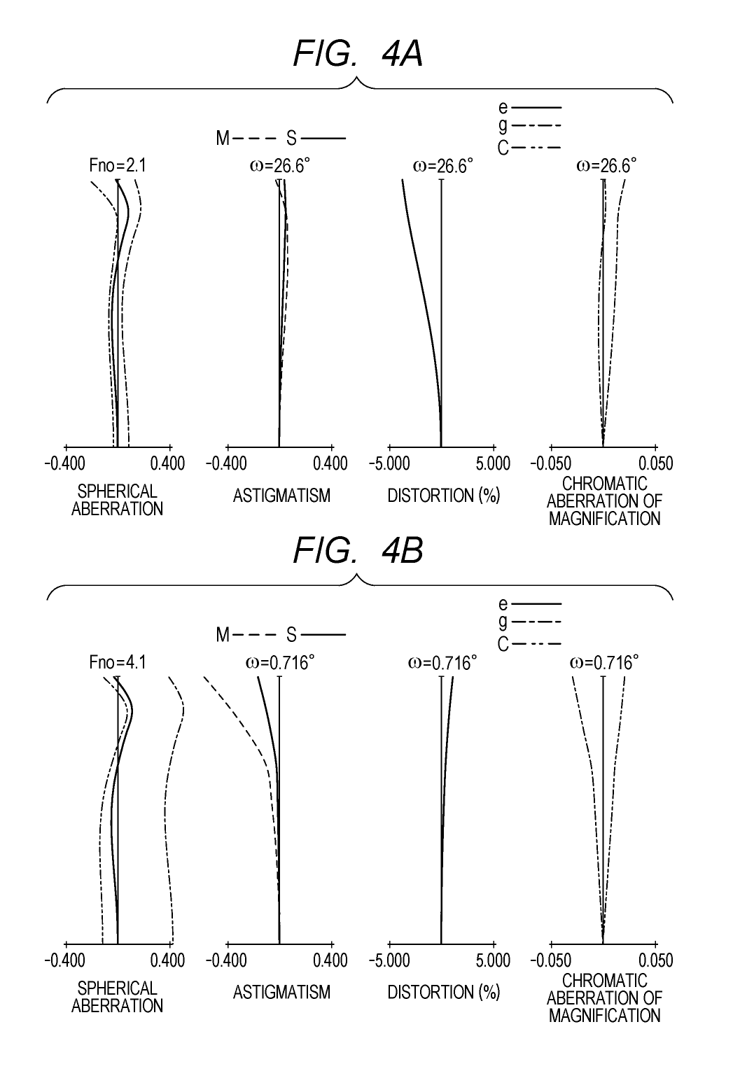

FIGS. 4A and 4B illustrate aberration diagrams when the zoom lens in Numerical Embodiment 2 focuses on the infinite object at the wide angle end and the telephoto end, respectively.

Table 1 shows values corresponding to each of the conditional expressions in Numerical Embodiment 2. Numerical Embodiment 2 satisfies Conditional Expressions (1) to (7). Thereby, the zoom lens of the present invention achieves a small-sized and lightweight imaging optical system having the high zoom ratio, the wide angle of view and the high optical performance at the telephoto end.

### Embodiment 3

The zoom lens of the Numerical Embodiment 3 of the present invention includes in order from an object side to an image side: a positive first lens unit that does not move for zooming and moves for focusing; a negative second lens unit that moves to the image side for zooming from the wide angle end to the telephoto end; a negative third lens unit that moves for zooming; a negative fourth lens unit that moves for zooming; a positive fifth lens unit that moves for zooming; and a positive relay lens unit that does not move for zooming.

The first lens unit includes in order from the object side to the image side, six lenses of positive, negative, positive, positive, positive and positive lenses.

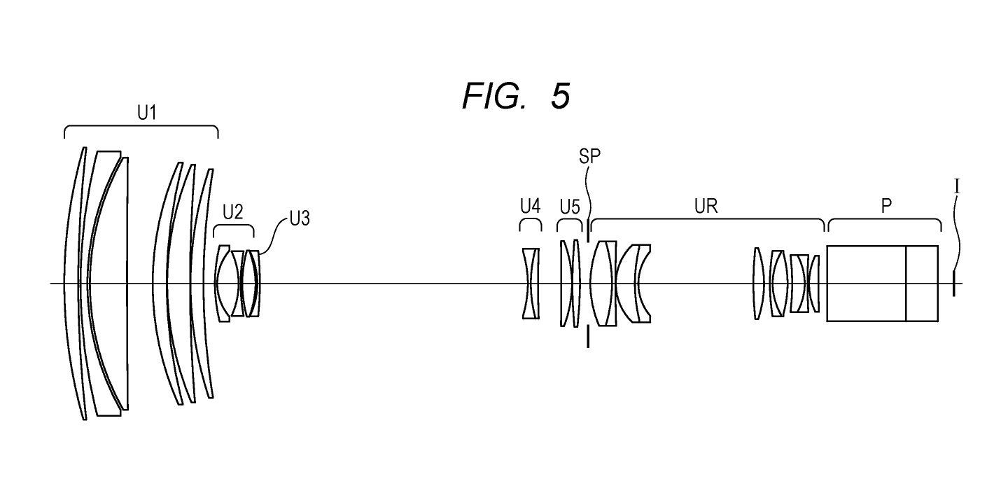

FIG. 5 is a sectional view of lenses at the time when the zoom lens in Numerical Embodiment 3 of the present invention focuses on an infinite object at the wide angle end. The first lens unit U1 has a positive refractive power and does not move for zooming. A part of the first lens unit moves from the image side to the object side for focusing from the infinite distance to a finite distance. A second lens unit (variator lens unit) U2 has a negative refractive power for zooming and moves to the image side for zooming from the wide angle end to the telephoto end. The third lens unit U3 has a negative refractive power and moves for zooming. A fourth lens unit U4 has a negative refractive power and moves for zooming. A fifth lens unit U5 has a positive refractive power and moves for zooming. An aperture stop SP is illustrated. The relay lens unit UR has a positive refractive power and does not move for zooming. The reference character P corresponds to an optical filter or a color separation optical system, and represents a glass block in the figure. An image plane I corresponds to an imaging plane of the image pickup element (photoelectric conversion element).

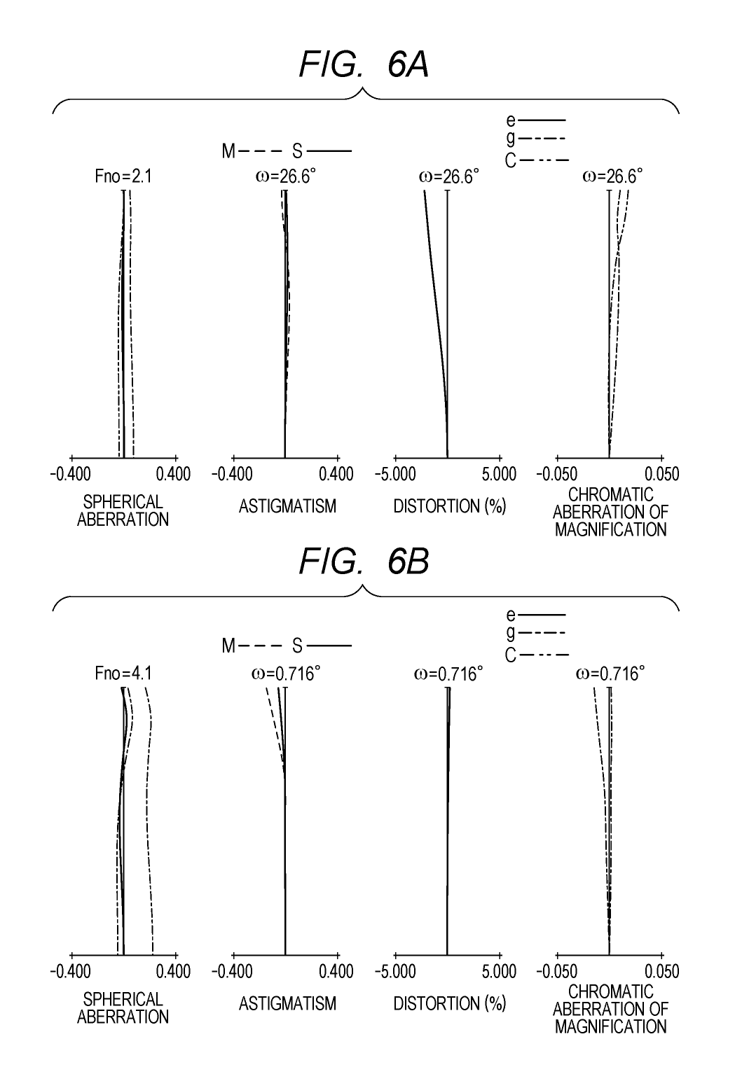

FIGS. 6A and 6B illustrate aberration diagrams when the zoom lens in Numerical Embodiment 3 focuses on the infinite object at the wide angle end and the telephoto end, respectively.

Table 1 shows values corresponding to each of the conditional expressions in Numerical Embodiment 3. Numerical Embodiment 3 satisfies Conditional Expressions (1) to (7). Thereby, the zoom lens of the present invention achieves a small-sized and lightweight imaging optical system having the high zoom ratio, the wide angle of view, and the high optical performance at the telephoto end.

### Embodiment 4

The zoom lens of the Numerical Embodiment 4 of the present invention includes in order from an object side to an image side: a positive first lens unit that does not move for zooming and moves for focusing; a negative second lens unit that moves to the image side for zooming from the wide angle end to the telephoto end; a negative third lens unit that moves for zooming; a negative fourth lens unit that moves for zooming; a positive fifth lens unit that moves for zooming; and a positive relay lens unit that does not move for zooming.

The first lens unit includes in order from the object side to the image side, six lenses of positive, negative, positive, positive, positive and positive lenses.

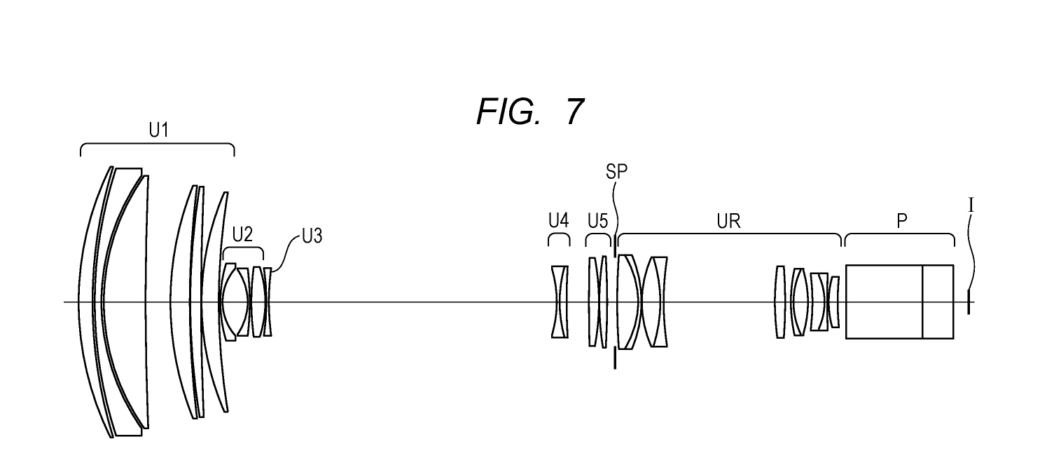

FIG. 7 is a sectional view of lenses at the time when the zoom lens in Numerical Embodiment 4 of the present invention focuses on an infinite object at the wide angle end. The first lens unit U1 has a positive refractive power and does not move for zooming. A part of the first lens unit moves from the image side to the object side for focusing from the infinite distance to a finite distance. A second lens unit (variator lens unit) U2 has a negative refractive power for zooming and moves to the image side for zooming from the wide angle end to the telephoto end. The third lens unit U3 has a negative refractive power and moves for zooming. A fourth lens unit U4 has a negative refractive power and moves for zooming. A fifth lens unit U5 has a positive refractive power and moves for zooming. An aperture stop SP is illustrated. The relay lens unit UR has a positive refractive power and does not move for zooming. The reference character P corresponds to an optical filter or a color separation optical system, and represents a glass block in the figure. An image plane I corresponds to an imaging plane of the image pickup element (photoelectric conversion element).

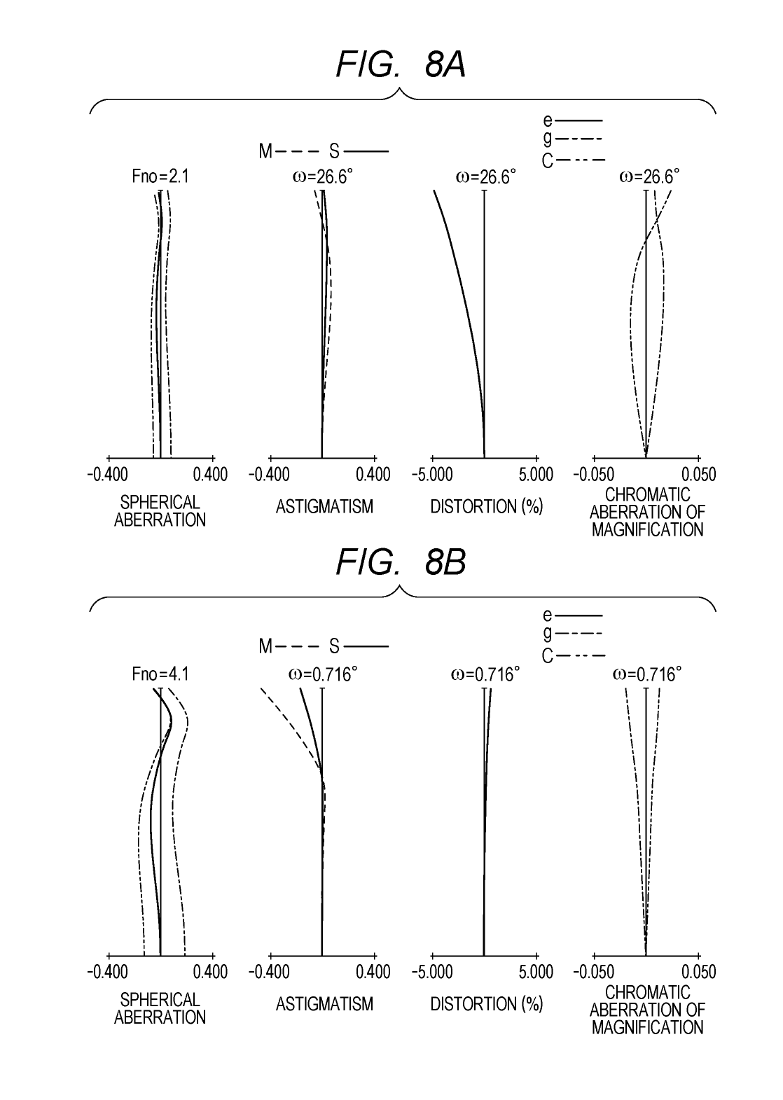

FIGS. 8A and 8B illustrate aberration diagrams when the zoom lens in Numerical Embodiment 4 focuses on the infinite object at the wide angle end and the telephoto end, respectively.

Table 1 shows values corresponding to each of the conditional expressions in Numerical Embodiment 4. Numerical Embodiment 4 satisfies Conditional Expressions (1) to (7). Thereby, the zoom lens of the present invention achieves a small-sized and lightweight imaging optical system having the high zoom ratio, the wide angle of view, and the high optical performance at the telephoto end.

### Embodiment 5

A zoom lens of the Numerical Embodiment 5 of the present invention includes in order from the object side to the image side: a positive first lens unit that does not move for zooming and moves for focusing; a negative second lens unit that moves to the image side for zooming from the wide angle end to the telephoto end; a negative third lens unit that moves for zooming; a positive fourth lens unit that moves for zooming; and a positive relay lens unit that does not move for zooming.

The first lens unit includes in order from the object side to the image side, six lenses of positive, negative, positive, positive, positive and positive lenses.

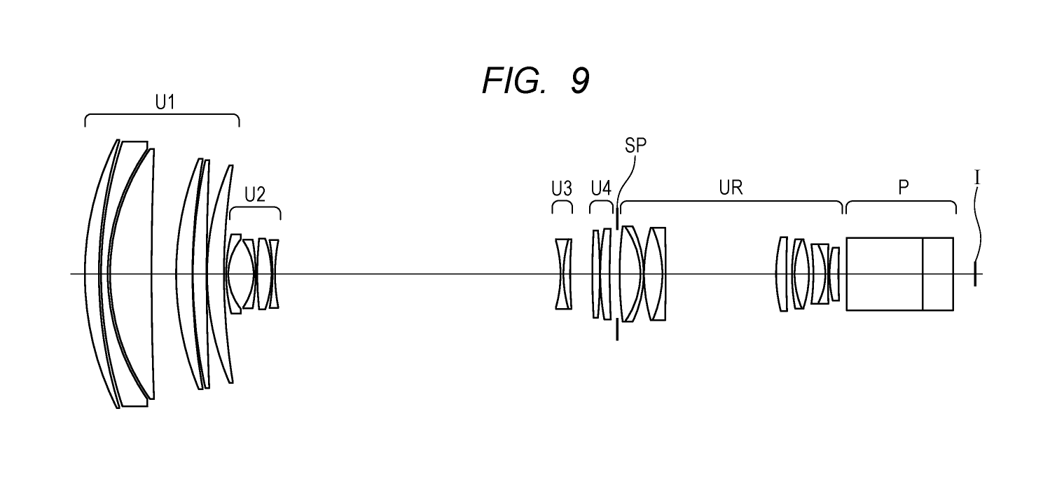

FIG. 9 is a sectional view of lenses at the time when the zoom lens in Numerical Embodiment 5 of the present invention focuses on an infinite object at the wide angle end. The first lens unit U1 has a positive refractive power and does not move for zooming. A part of the first lens unit moves from the image side to the object side for focusing from the infinite distance to a finite distance. A second lens unit (variator lens unit) U2 has a negative refractive power for zooming and moves to the image side for zooming from the wide angle end to the telephoto end. The third lens unit U3 has a negative refractive power and moves for zooming. A fourth lens unit U4 has a positive refractive power and moves for zooming. An aperture stop SP is illustrated. The relay lens unit UR has a positive refractive power and does not move for zooming. The reference character P corresponds to an optical filter or a color separation optical system, and represents a glass block in the figure. An image plane I corresponds to an imaging plane of the image pickup element (photoelectric conversion element).

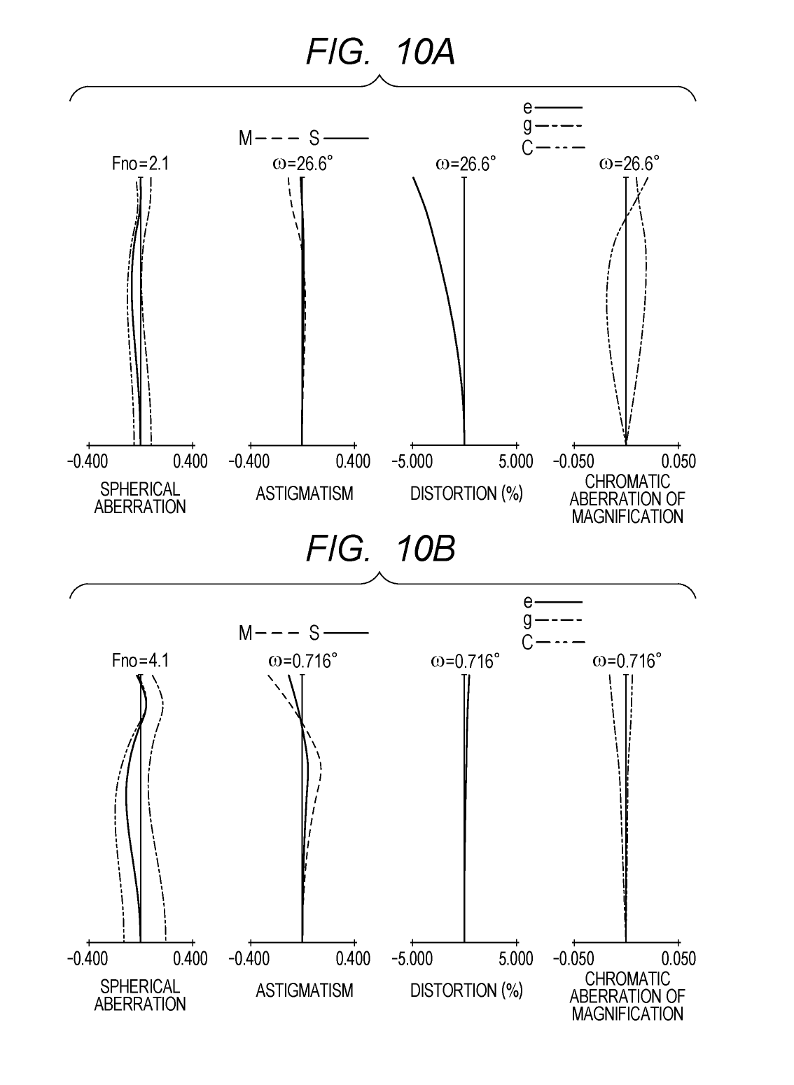

FIGS. 10A and 10B illustrate aberration diagrams when the zoom lens in Numerical Embodiment 5 focuses on the infinite object at the wide angle end and the telephoto end, respectively.

Table 1 shows values corresponding to each of the conditional expressions in Numerical Embodiment 5. Numerical Embodiment 5 satisfies Conditional Expressions (1) to (7). Thereby, the zoom lens of the present invention achieves a small-sized and lightweight imaging optical system having the high zoom ratio, the wide angle of view and the high optical performance at the telephoto end.

### Embodiment 6

A zoom lens of the Numerical Embodiment 6 of the present invention includes in order from the object side to the image side: a positive first lens unit that does not move for zooming and moves for focusing; a negative second lens unit that moves to the image side for zooming from the wide angle end to the telephoto end; a positive third lens unit that moves for zooming; a positive fourth lens unit that moves for zooming; and a positive relay lens unit that does not move for zooming.

The first lens unit includes in order from the object side to the image side, five lenses of negative, positive, positive, positive and positive lenses.

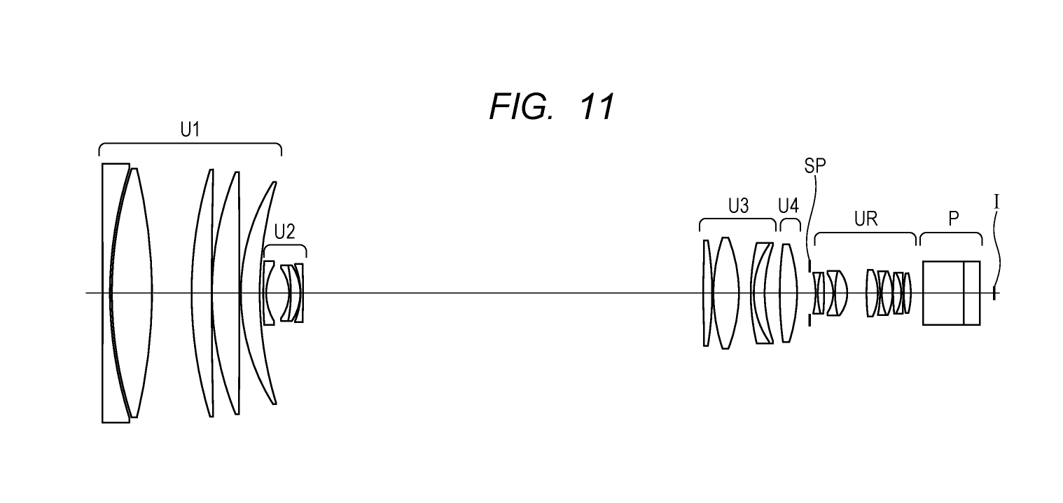

FIG. 11 is a sectional view of lenses at the time when the zoom lens in Numerical Embodiment 6 of the present invention focuses on an infinite object at the wide angle end. The first lens unit U1 has a positive refractive power and does not move for zooming. A part of the first lens unit moves from the image side to the object side for focusing from the infinite distance to a finite distance. A second lens unit (variator lens unit) U2 has a negative refractive power for zooming and moves to the image side for zooming from the wide angle end to the telephoto end. The third lens unit U3 has a positive refractive power and moves for zooming. A fourth lens unit U4 has a positive refractive power and moves for zooming. An aperture stop SP is illustrated. The relay lens unit UR has a positive refractive power and does not move for zooming. The reference character P corresponds to an optical filter or a color separation optical system, and represents a glass block in the figure. An image plane I corresponds to an imaging plane of the image pickup element (photoelectric conversion element).

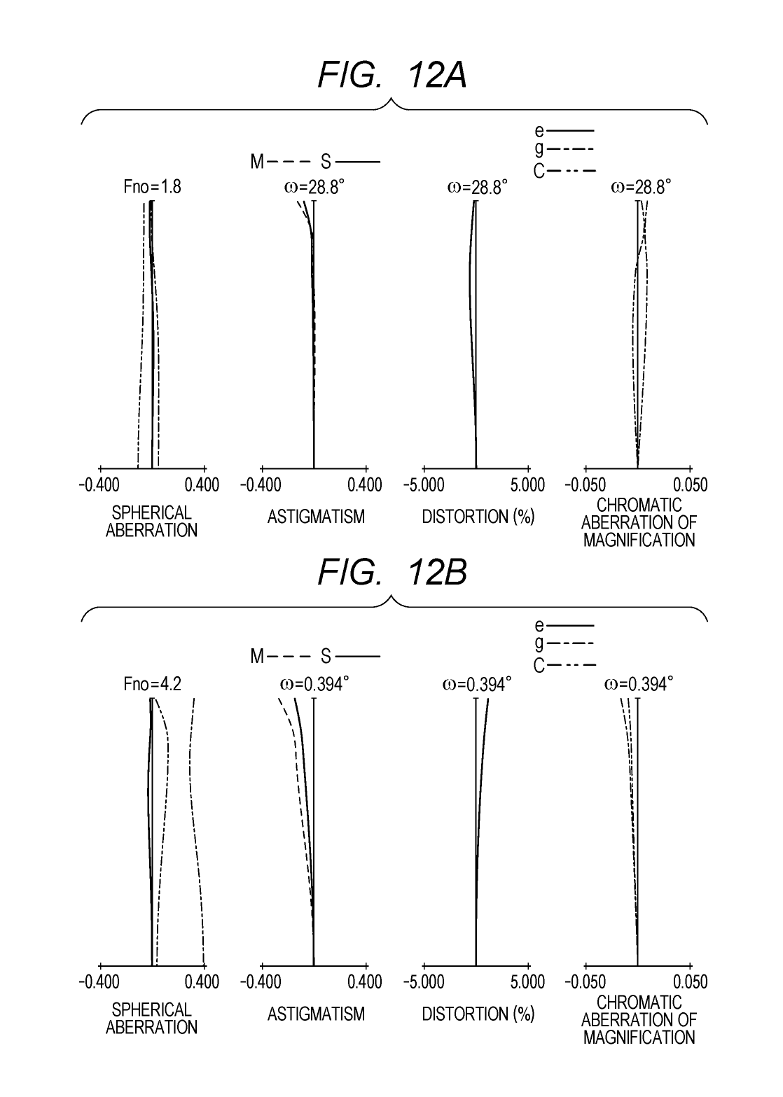

FIGS. 12A and 12B illustrate aberration diagrams when the zoom lens in Numerical Embodiment 6 focuses on the infinite object at the wide angle end and the telephoto end, respectively.

Table 1 shows values corresponding to each of the conditional expressions in Numerical Embodiment 6. The Numerical Embodiment 6 satisfies Conditional Expressions (1) to (7). Thereby, the zoom lens of the present invention achieves a small-sized and lightweight imaging optical system having the high zoom ratio, the wide angle of view and the high optical performance at the telephoto end.

### Embodiment 7

The zoom lens of the Numerical Embodiment 7 of the present invention includes in order from an object side to an image side: a positive first lens unit which does not move for zooming and moves for focusing; a negative second lens unit which moves to the image side for zooming from the wide angle end to the telephoto end; a negative third lens unit which moves for zooming; a positive fourth lens unit which moves for zooming; and a positive relay lens unit that does not move for zooming.

The first lens unit includes in order from the object side to the image side, five lenses of negative, positive, positive, positive and positive lenses.

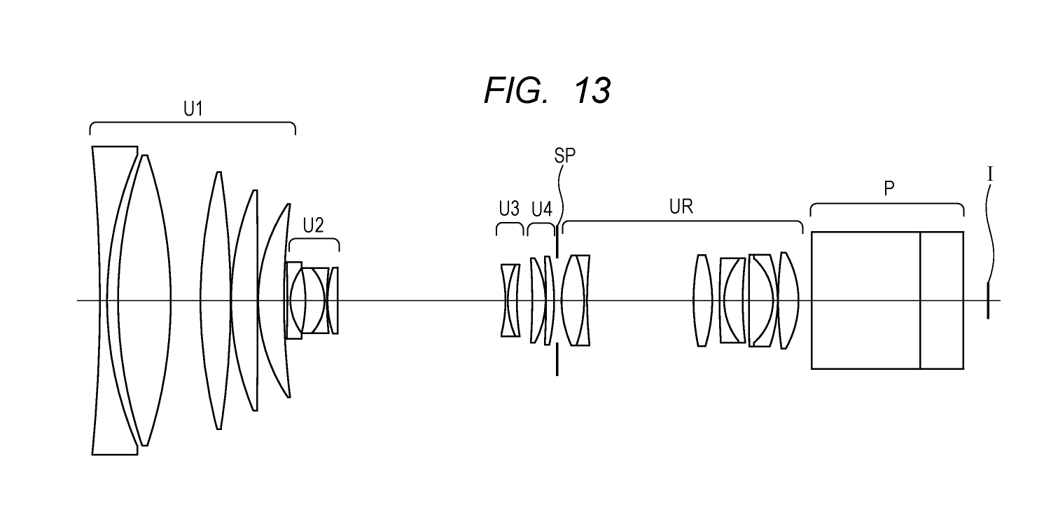

FIG. 13 is a sectional view of lenses at the time when the zoom lens in Numerical Embodiment 7 of the present invention focuses on an infinite object at the wide angle end. The first lens unit U1 has a positive refractive power and does not move for zooming. A part of the first lens unit moves from the image side to the object side for focusing from the infinite distance to a finite distance. A second lens unit (variator lens unit) U2 has a negative refractive power for zooming and moves to the image side for zooming from the wide angle end to the telephoto end. The third lens unit U3 has a negative refractive power and moves for zooming. A fourth lens unit U4 has a positive refractive power and moves for zooming. An aperture stop SP is illustrated. The relay lens unit UR has a positive refractive power and does not move for zooming. The reference character P corresponds to an optical filter or a color separation optical system, and represents a glass block in the figure. An image plane I corresponds to an imaging plane of the image pickup element (photoelectric conversion element).

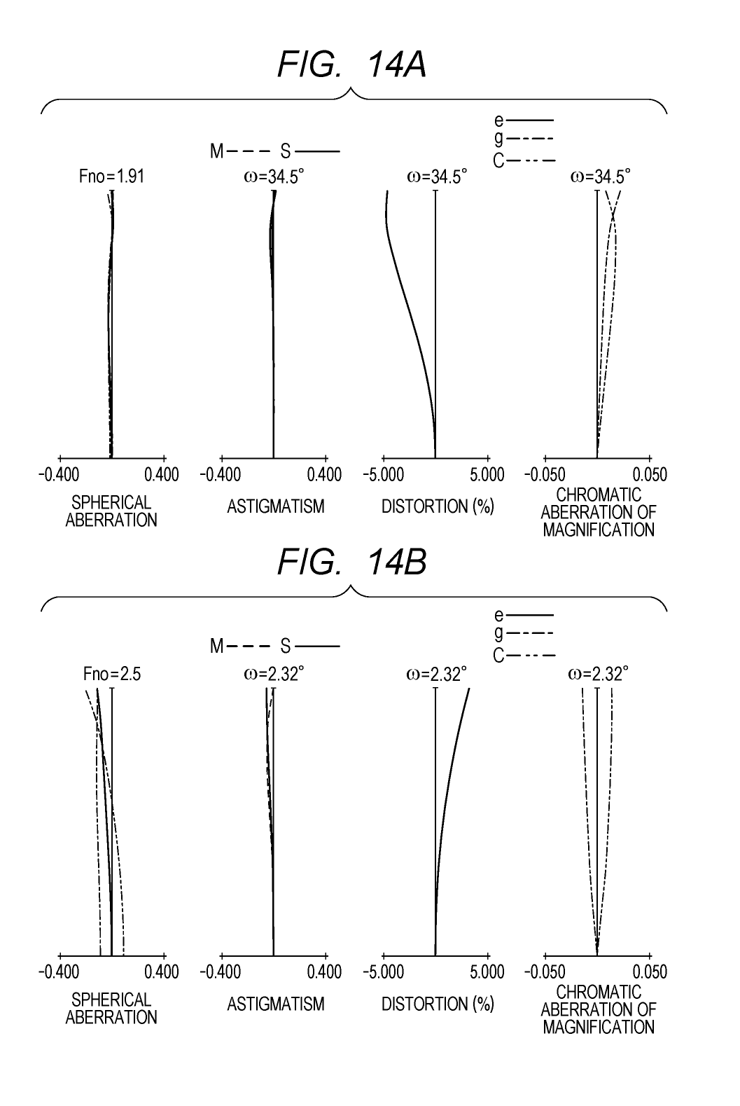

FIGS. 14A and 14B illustrate aberration diagrams when the zoom lens in Numerical Embodiment 7 focuses on the infinite object at the wide angle end and the telephoto end, respectively.

Table 1 shows values corresponding to each of conditional expressions in Numerical Embodiment 7. Numerical Embodiment 7 satisfies Conditional Expressions (1) to (7). Thereby, the zoom lens of the present invention achieves a small-sized and lightweight imaging optical system having the high zoom ratio, the wide angle of view and the high optical performance at the telephoto end.

Numeric data of each of the following Numerical Embodiments 1 to 7 is shown. In each of the numerical data, i represents a surface number counted from the object side, ri represents a radius of curvature of the i-th surface from the object side, di represents a distance between the i-th surface and the (i+1)-th surface, ndi and νdi represent a refractive index to d-line (587.6 nm) and the Abbe number of the optical member between the i-th surface and the (i+1)-th surface.

Incidentally, when the refractive indices with respect to the g-line, the F-line, the d-line, and the C-line of the Fraunhofer line are represented by Ng, NF, Nd and NC, definitions of the Abbe number νd and the partial dispersion ratio θgf are represented by the following expressions which are generally used:

νd=(Nd−1)/(NF−NC); and

θgf=(Ng−NF)/(NF−NC).

When an optical axis direction is determined to be an X-axis, a direction perpendicular to the optical axis is determined to be an H-axis, a traveling direction of light is determined to be positive, R represents a paraxial radius of curvature, k represents a conic constant, and A3, A4, A5, A6, A7, A8, A9, A10, A11, A12, A13, A14, A15 and A16 each represent an aspherical coefficient, an aspherical surface shape is expressed by the following expression.

$$X = \frac{{H}^{2} / R}{1 + \sqrt{1 - ( 1 + k ) {( H / R )}^{2}}} + A 4 {H}^{4} + A 6 {H}^{6} + A 8 {H}^{8} + A 10 {H}^{10} + A 12 {H}^{12} + A 14 {H}^{14} + A 16 {H}^{16} + A 3 {H}^{3} + A 5 {H}^{5} + A 7 {H}^{7} + A 9 {H}^{9} + A 11 {H}^{11} + A 13 {H}^{13} + A 15 {H}^{15}$$

In addition, in the numerical data, “e-Z” means “×10^{-Z}”. A mark * attached to the side of the surface number indicates that the optical surface is aspherical.

### Numerical Embodiment 1

Unit mm

Surface data

| Surface | | | | | | Effective | |
|---|---|---|---|---|---|---|---|
| number i | ri | di | ndi | vdi | θgFi | diameter | Focal length |
| 1 | 183.38205 | 3.00000 | 1.851500 | 40.78 | 0.5695 | 107.317 | −299.999 |
| 2 | 106.20042 | 1.07300 | | | | 104.856 | |
| 3 | 105.24783 | 15.02434 | 1.433870 | 95.10 | 0.5373 | 105.542 | 277.864 |
| 4 | 779.51784 | 11.15000 | | | | 105.422 | |
| 5 | 165.31760 | 6.12449 | 1.433870 | 95.10 | 0.5373 | 105.304 | 669.343 |
| 6 | 378.23664 | 0.20000 | | | | 105.061 | |
| 7 | 160.28421 | 7.18852 | 1.433870 | 95.10 | 0.5373 | 104.154 | 537.649 |
| 8 | 502.55531 | 0.20000 | | | | 103.770 | |
| 9 | 138.33041 | 9.68950 | 1.433870 | 95.10 | 0.5373 | 101.093 | 358.855 |
| 10 | 1190.11331 | (Variable) | | | | 100.504 | |
| 11 | 78.49053 | 1.00000 | 2.003300 | 28.27 | 0.5980 | 29.896 | −27.011 |
| 12 | 20.13981 | 8.91847 | | | | 25.967 | |
| 13 | −31.92813 | 0.90000 | 1.816000 | 46.62 | 0.5568 | 25.580 | −42.349 |
| 14 | −400.35824 | 0.70000 | | | | 26.428 | |
| 15 | 65.72626 | 4.13898 | 1.922860 | 18.90 | 0.6495 | 27.396 | 38.945 |
| 16 | −79.02840 | 2.23382 | | | | 27.392 | |
| 17 | −66.32430 | 1.10000 | 1.816000 | 46.62 | 0.5568 | 26.678 | −110.486 |
| 18 | −249.25223 | (Variable) | | | | 26.682 | |
| 19 | −47.61650 | 1.30000 | 1.717004 | 47.92 | 0.5605 | 28.434 | −36.201 |
| 20 | 58.34616 | 3.27859 | 1.846490 | 23.90 | 0.6217 | 30.416 | 79.554 |
| 21 | 400.18520 | (Variable) | | | | 30.870 | |
| 22 | ∞ | 4.05388 | | | | 37.218 | |
| 23 | 226.67058 | 6.75742 | 1.607379 | 56.81 | 0.5483 | 40.360 | 70.385 |
| 24 | −52.36155 | 0.15000 | | | | 40.885 | |
| 25 | 3180.72058 | 3.29188 | 1.518229 | 58.90 | 0.5457 | 40.838 | 231.404 |
| 26 | −125.09849 | 0.35000 | | | | 40.820 | |
| 27 | 39.06865 | 9.43204 | 1.487490 | 70.23 | 0.5300 | 39.408 | 58.436 |
| 28 | −98.06367 | 1.50000 | 1.834000 | 37.17 | 0.5774 | 38.312 | −121.818 |
| 29 | −2415.03003 | 0.15000 | | | | 37.274 | |
| 30 | 36.73108 | 8.30910 | 1.487490 | 70.23 | 0.5300 | 34.520 | 53.864 |
| 31 | −86.27365 | 1.50000 | 1.882997 | 40.76 | 0.5667 | 32.687 | −25.097 |
| 32 | 30.30129 | 50.00000 | | | | 29.408 | |
| 33 | −120.62916 | 4.64093 | 1.517417 | 52.43 | 0.5564 | 31.772 | 94.501 |
| 34 | −35.36457 | 2.54355 | | | | 32.006 | |
| 35 | 63.07563 | 1.20000 | 1.785896 | 44.20 | 0.5631 | 29.131 | −82.516 |
| 36 | 31.79036 | 6.49533 | 1.517417 | 52.43 | 0.5564 | 28.010 | 48.172 |
| 37 | −109.65039 | 2.01000 | | | | 27.264 | |
| 38 | 76.16107 | 5.44373 | 1.517417 | 52.43 | 0.5564 | 24.801 | 48.054 |
| 39 | −36.25647 | 1.20000 | 1.834807 | 42.71 | 0.5642 | 23.497 | −24.462 |
| 40 | 48.07162 | 0.66799 | | | | 22.402 | |
| 41 | 33.72522 | 4.04093 | 1.487490 | 70.23 | 0.5300 | 22.524 | 67.643 |
| 42 | −1680.64571 | 3.80000 | | | | 22.178 | |
| 43 | ∞ | 34.37500 | 1.608590 | 46.44 | 0.5664 | 31.250 | |
| 44 | ∞ | 13.75000 | 1.516800 | 64.17 | 0.5347 | 31.250 | |
| 45 | ∞ | 0.00000 | | | | 31.250 | |

Various data
Zoom ratio 40.00

| | Wide angle | Middle | Telephoto |
|---|---|---|---|
| Focal length | 11.00 | 69.58 | 440.00 |
| F number | 2.10 | 2.10 | 4.10 |
| Half angle of view | 26.57 | 4.52 | 0.72 |
| Image height | 5.50 | 5.50 | 5.50 |
| Total lens length | 387.49 | 387.49 | 387.49 |
| BF | 9.54 | 9.54 | 9.54 |
| d10 | 1.22 | 91.07 | 120.94 |
| d18 | 123.69 | 21.43 | 12.31 |
| d21 | 10.16 | 22.57 | 1.82 |
| d45 | 9.54 | 9.54 | 9.54 |
| Entrance pupil position | 74.99 | 549.83 | 2183.07 |
| Exit pupil position | 756.96 | 756.96 | 756.96 |
| Front principal point position | 86.15 | 625.88 | 2882.10 |
| Rear principal point position | −1.46 | −60.04 | −430.46 |

Zoom lens unit data

| | Leading | | Lens configuration | Front principal point | Rear principal point |
|---|---|---|---|---|---|
| Unit | surface | Focal length | length | position | position |
| 1 | 1 | 161.84 | 53.65 | 26.24 | −15.14 |
| 2 | 11 | −22.41 | 18.99 | 1.63 | −13.63 |
| 3 | 19 | −66.60 | 4.58 | 0.24 | −2.27 |
| 4 | 22 | 87.71 | 165.66 | 96.66 | −190.05 |

Single lens data

| Lens | Leading surface | Focal length |
|---|---|---|
| 1 | 1 | −300.00 |
| 2 | 3 | 277.86 |
| 3 | 5 | 669.34 |
| 4 | 7 | 537.65 |
| 5 | 9 | 358.86 |
| 6 | 11 | −27.01 |
| 7 | 13 | −42.35 |
| 8 | 15 | 38.94 |
| 9 | 17 | −110.49 |
| 10 | 19 | −36.20 |
| 11 | 20 | 79.55 |
| 12 | 23 | 70.38 |
| 13 | 25 | 231.40 |
| 14 | 27 | 58.44 |
| 15 | 28 | −121.82 |
| 16 | 30 | 53.86 |
| 17 | 31 | −25.10 |
| 18 | 33 | 94.50 |
| 19 | 35 | −82.52 |
| 20 | 36 | 48.17 |
| 21 | 38 | 48.05 |
| 22 | 39 | −24.46 |
| 23 | 41 | 67.64 |
| 24 | 43 | |
| 25 | 44 | |

### Numerical Embodiment 2

Unit mm

Surface data

| Surface | | | | | | Effective | |
|---|---|---|---|---|---|---|---|
| number i | ri | di | ndi | vdi | θgFi | diameter | Focal length |
| 1 | 244.49912 | 3.00000 | 1.851500 | 40.78 | 0.5695 | 107.317 | −249.990 |
| 2 | 113.50168 | 1.07300 | | | | 105.259 | |
| 3 | 113.09472 | 16.49967 | 1.438750 | 94.93 | 0.5340 | 106.008 | 225.766 |
| 4 | −778.08590 | 11.15000 | | | | 106.048 | |
| 5 | 131.53389 | 7.09222 | 1.496999 | 81.54 | 0.5375 | 105.522 | 499.736 |
| 6 | 273.70166 | 0.20000 | | | | 105.178 | |
| 7 | 141.78804 | 8.13059 | 1.496999 | 81.54 | 0.5375 | 103.917 | 405.638 |
| 8 | 465.55777 | 0.20000 | | | | 103.427 | |
| 9 | 263.20879 | 4.85331 | 1.496999 | 81.54 | 0.5375 | 102.191 | 718.636 |
| 10 | 986.38007 | (Variable) | | | | 101.629 | |
| 11 | 228.28308 | 1.00000 | 2.003300 | 28.27 | 0.5980 | 29.404 | −24.189 |
| 12 | 22.05348 | 8.46763 | | | | 25.929 | |
| 13 | −31.93035 | 0.90000 | 1.816000 | 46.62 | 0.5568 | 25.788 | −40.325 |
| 14 | −936.02346 | 0.70000 | | | | 26.986 | |
| 15 | 73.32401 | 4.25046 | 1.922860 | 18.90 | 0.6495 | 28.321 | 40.399 |
| 16 | −75.60692 | (Variable) | | | | 28.480 | |
| 17 | −1238.40219 | 1.10000 | 1.816000 | 46.62 | 0.5568 | 28.202 | −330.976 |
| 18 | 347.80223 | (Variable) | | | | 28.092 | |
| 19 | −45.71318 | 1.30000 | 1.717004 | 47.92 | 0.5605 | 30.776 | −35.904 |
| 20 | 60.31471 | 3.66203 | 1.846490 | 23.90 | 0.6217 | 33.255 | 78.338 |
| 21 | 590.34562 | (Variable) | | | | 33.752 | |
| 22 | ∞ | 4.05388 | | | | 40.157 | |
| 23 | 226.67058 | 6.75742 | 1.607379 | 56.81 | 0.5483 | 43.554 | 70.385 |
| 24 | −52.36155 | 0.15000 | | | | 43.841 | |
| 25 | 3180.72058 | 3.29188 | 1.518229 | 58.90 | 0.5457 | 43.661 | 231.404 |
| 26 | −125.09849 | 0.35000 | | | | 43.624 | |
| 27 | 39.06865 | 9.43204 | 1.487490 | 70.23 | 0.5300 | 41.707 | 58.436 |
| 28 | −98.06367 | 1.50000 | 1.834000 | 37.17 | 0.5774 | 41.031 | −121.818 |
| 29 | −2415.03003 | 0.15000 | | | | 39.789 | |
| 30 | 36.73108 | 8.30910 | 1.487490 | 70.23 | 0.5300 | 36.369 | 53.864 |
| 31 | −86.27365 | 1.50000 | 1.882997 | 40.76 | 0.5667 | 34.971 | −25.097 |
| 32 | 30.30129 | 50.00000 | | | | 31.056 | |
| 33 | −120.62916 | 4.64093 | 1.517417 | 52.43 | 0.5564 | 32.985 | 94.501 |
| 34 | −35.36457 | 2.54355 | | | | 33.186 | |
| 35 | 63.07563 | 1.20000 | 1.785896 | 44.20 | 0.5631 | 29.880 | −82.516 |
| 36 | 31.79036 | 6.49533 | 1.517417 | 52.43 | 0.5564 | 28.660 | 48.172 |
| 37 | −109.65039 | 2.01000 | | | | 27.924 | |
| 38 | 76.16107 | 5.44373 | 1.517417 | 52.43 | 0.5564 | 25.225 | 48.054 |
| 39 | −36.25647 | 1.20000 | 1.834807 | 42.71 | 0.5642 | 23.900 | −24.462 |
| 40 | 48.07162 | 0.66799 | | | | 22.464 | |
| 41 | 33.72522 | 4.04093 | 1.487490 | 70.23 | 0.5300 | 22.346 | 75.719 |
| 42 | 362.22377 | 3.80000 | | | | 21.915 | |
| 43 | ∞ | 34.37500 | 1.608590 | 46.44 | 0.5664 | 31.250 | |
| 44 | ∞ | 13.75000 | 1.516800 | 64.17 | 0.5347 | 31.250 | |
| 45 | ∞ | 0.00000 | | | | 31.250 | |

Various data
Zoom ratio 40.00

| | Wide angle | Middle | Telephoto |
|---|---|---|---|
| Focal length | 11.00 | 69.55 | 440.00 |
| F number | 2.10 | 2.09 | 4.10 |
| Half angle of view | 26.57 | 4.52 | 0.72 |
| Image height | 5.50 | 5.50 | 5.50 |
| Total lens length | 401.74 | 401.74 | 401.74 |
| BF | 10.07 | 10.07 | 10.07 |
| d10 | 0.68 | 94.56 | 123.53 |
| d16 | 0.50 | 7.52 | 5.54 |
| d18 | 141.39 | 30.16 | 21.57 |
| d21 | 9.86 | 20.19 | 1.79 |
| d45 | 10.07 | 10.07 | 10.07 |
| Entrance pupil position | 69.84 | 579.13 | 2533.83 |
| Exit pupil position | −2683.52 | −2683.52 | −2683.52 |
| Front principal point position | 80.80 | 646.89 | 2901.96 |
| Rear principal point position | −0.93 | −59.48 | −429.93 |

Zoom lens unit data

| | Leading | | Lens configuration | Front principal point | Rear principal point |
|---|---|---|---|---|---|
| Unit | surface | Focal length | length | position | position |
| 1 | 1 | 161.84 | 52.20 | 26.30 | −12.92 |
| 2 | 11 | −26.93 | 15.32 | −1.30 | −15.13 |
| 3 | 17 | −330.98 | 1.10 | 0.47 | −0.13 |
| 4 | 19 | −66.60 | 4.96 | 0.15 | −2.57 |
| 5 | 22 | 78.88 | 165.66 | 76.48 | −174.36 |

Single lens data

| Lens | Leading surface | Focal length |
|---|---|---|
| 1 | 1 | −249.99 |
| 2 | 3 | 225.77 |
| 3 | 5 | 499.74 |
| 4 | 7 | 405.64 |
| 5 | 9 | 718.64 |
| 6 | 11 | −24.19 |
| 7 | 13 | −40.32 |
| 8 | 15 | 40.40 |
| 9 | 17 | −330.98 |
| 10 | 19 | −35.90 |
| 11 | 20 | 78.34 |
| 12 | 23 | 70.38 |
| 13 | 25 | 231.40 |
| 14 | 27 | 58.44 |
| 15 | 28 | −121.82 |
| 16 | 30 | 53.86 |
| 17 | 31 | −25.10 |
| 18 | 33 | 94.50 |
| 19 | 35 | −82.52 |
| 20 | 36 | 48.17 |
| 21 | 38 | 48.05 |
| 22 | 39 | −24.46 |
| 23 | 41 | 75.72 |
| 24 | 43 | |
| 25 | 44 | |

### Numerical Embodiment 3

Unit mm

Surface data

| Surface | | | | | | Effective | |
|---|---|---|---|---|---|---|---|
| number i | ri | di | ndi | vdi | θgFi | diameter | Focal length |
| 1 | 210.06296 | 6.07687 | 1.433870 | 95.10 | 0.5373 | 114.266 | 839.438 |
| 2 | 490.30405 | 1.00000 | | | | 113.593 | |
| 3 | 224.56033 | 3.00000 | 1.834807 | 42.71 | 0.5642 | 110.962 | −259.997 |
| 4 | 110.00664 | 1.07300 | | | | 105.788 | |
| 5 | 109.04325 | 16.13909 | 1.433870 | 95.10 | 0.5373 | 105.664 | 256.741 |
| 6 | 4424.50288 | 11.15000 | | | | 104.555 | |
| 7 | 126.24493 | 6.11321 | 1.433870 | 95.10 | 0.5373 | 101.236 | 800.585 |
| 8 | 195.13718 | 0.20000 | | | | 100.517 | |
| 9 | 129.34490 | 9.93743 | 1.433870 | 95.10 | 0.5373 | 99.584 | 374.873 |
| 10 | 611.07033 | 0.20000 | | | | 98.741 | |
| 11 | 154.85895 | 5.63552 | 1.433870 | 95.10 | 0.5373 | 95.574 | 745.713 |
| 12 | 293.07570 | (Variable) | | | | 94.468 | |
| 13 | 65.47852 | 1.00000 | 2.001000 | 29.13 | 0.5997 | 31.533 | −32.710 |
| 14 | 21.77703 | 9.28763 | | | | 27.329 | |
| 15 | −33.08475 | 0.90000 | 1.772499 | 49.60 | 0.5520 | 26.228 | −29.606 |
| 16 | 76.14260 | 0.70000 | | | | 26.527 | |
| 17 | 51.41584 | 5.76983 | 1.808095 | 22.76 | 0.6307 | 27.066 | 27.734 |
| 18 | −38.42118 | (Variable) | | | | 27.014 | |
| 19 | −31.39479 | 1.10000 | 1.772499 | 49.60 | 0.5520 | 26.824 | −53.218 |
| 20 | −132.82260 | (Variable) | | | | 26.958 | |
| 21 | −46.68721 | 1.30000 | 1.717004 | 47.92 | 0.5605 | 26.638 | −35.047 |
| 22 | 55.64767 | 3.15746 | 1.846490 | 23.90 | 0.6217 | 28.414 | 74.308 |
| 23 | 437.24951 | (Variable) | | | | 28.851 | |
| 24 | −2927.66593 | 4.71791 | 1.607379 | 56.81 | 0.5483 | 34.908 | 82.748 |
| 25 | −49.64514 | 0.15000 | | | | 35.462 | |
| 26 | 195.10408 | 3.29607 | 1.518229 | 58.90 | 0.5457 | 36.055 | 165.933 |
| 27 | −153.98173 | (Variable) | | | | 36.094 | |
| 28 | ∞ | 1.00000 | | | | 35.520 | |
| 29 | 44.79306 | 9.43204 | 1.487490 | 70.23 | 0.5300 | 35.148 | 54.269 |
| 30 | −60.65636 | 1.50000 | 1.834000 | 37.17 | 0.5774 | 34.030 | −65.046 |
| 31 | 552.48592 | 0.15000 | | | | 33.416 | |
| 32 | 22.85959 | 8.30910 | 1.487490 | 70.23 | 0.5300 | 32.004 | 68.066 |
| 33 | 64.22955 | 1.50000 | 1.882997 | 40.76 | 0.5667 | 29.477 | −36.446 |
| 34 | 21.28610 | 50.00000 | | | | 26.518 | |
| 35 | 137.04791 | 4.64093 | 1.517417 | 52.43 | 0.5564 | 29.348 | 67.749 |
| 36 | −46.84111 | 2.54355 | | | | 29.298 | |
| 37 | 85.64039 | 1.20000 | 1.785896 | 44.20 | 0.5631 | 26.827 | −49.105 |
| 38 | 26.53665 | 6.49533 | 1.517417 | 52.43 | 0.5564 | 25.555 | 33.780 |
| 39 | −47.54557 | 2.01000 | | | | 25.175 | |
| 40 | −99.45718 | 5.44373 | 1.517417 | 52.43 | 0.5564 | 23.364 | 63.428 |
| 41 | −25.22374 | 1.20000 | 1.834807 | 42.71 | 0.5642 | 22.624 | −26.572 |
| 42 | 197.04397 | 0.66799 | | | | 22.637 | |
| 43 | 28.37669 | 4.04093 | 1.487490 | 70.23 | 0.5300 | 22.921 | 64.833 |
| 44 | 257.13129 | 3.80000 | | | | 22513 | |
| 45 | ∞ | 34.37500 | 1.608590 | 46.44 | 0.5664 | 31.250 | |
| 46 | ∞ | 13.75000 | 1.516800 | 64.17 | 0.5347 | 31.250 | |
| 47 | ∞ | 0.00000 | | | | 31.250 | |

Various data
Zoom ratio 40.00

| | Wide angle | Middle | Telephoto |
|---|---|---|---|
| Focal length | 11.00 | 69.57 | 440.00 |
| F number | 2.10 | 2.11 | 4.10 |
| Half angle of view | 26.57 | 4.52 | 0.72 |
| Image height | 5.50 | 5.50 | 5.50 |
| Total lens length | 386.75 | 386.75 | 386.75 |
| BF | 7.00 | 7.00 | 7.00 |
| d12 | 4.98 | 86.61 | 115.00 |
| d18 | 0.80 | 8.33 | 1.29 |
| d20 | 116.48 | 12.76 | 16.70 |
| d23 | 10.04 | 25.02 | 1.80 |
| d27 | 3.50 | 3.08 | 1.00 |
| d47 | 7.00 | 7.00 | 7.00 |
| Entrance pupil position | 93.01 | 624.56 | 2842.83 |
| Exit pupil position | 387.71 | 387.71 | 387.71 |
| Front principal point position | 104.33 | 706.85 | 3791.34 |
| Rear principal point position | −4.00 | −62.58 | −433.00 |

Zoom lens unit data

| | Leading | | Lens configuration | Front principal point | Rear principal point |
|---|---|---|---|---|---|
| Unit | surface | Focal length | length | position | position |
| 1 | 1 | 161.84 | 60.53 | 25.66 | −21.45 |
| 2 | 13 | −50.34 | 17.66 | −7.25 | −26.41 |
| 3 | 19 | −53.22 | 1.10 | −0.19 | −0.81 |
| 4 | 21 | −66.60 | 4.46 | 0.20 | −2.25 |
| 5 | 24 | 55.51 | 8.16 | 3.42 | −1.84 |
| 6 | 28 | 72.86 | 152.06 | 87.20 | −55.33 |

Single lens data

| Lens | Leading surface | Focal length |
|---|---|---|
| 1 | 1 | 839.44 |
| 2 | 3 | −260.00 |
| 3 | 5 | 256.74 |
| 4 | 7 | 800.58 |
| 5 | 9 | 374.87 |
| 6 | 11 | 745.71 |
| 7 | 13 | −32.71 |
| 8 | 15 | −29.61 |
| 9 | 17 | 27.73 |
| 10 | 19 | −53.22 |
| 11 | 21 | −35.05 |
| 12 | 22 | 74.31 |
| 13 | 24 | 82.75 |
| 14 | 26 | 165.93 |
| 15 | 29 | 54.27 |
| 16 | 30 | −65.05 |
| 17 | 32 | 68.07 |
| 18 | 33 | −36.45 |
| 19 | 35 | 67.75 |
| 20 | 37 | −49.10 |
| 21 | 38 | 33.78 |
| 22 | 40 | 63.43 |
| 23 | 41 | −26.57 |
| 24 | 43 | 64.83 |
| 25 | 45 | |
| 26 | 46 | |

### Numerical Embodiment 4

Unit mm
Surface data

| Surface | | | | | | Effective | Focal |
|---|---|---|---|---|---|---|---|
| number i | ri | di | ndi | vdi | θgFi | diameter | length |
| 1 | 133.75354 | 6.24833 | 1.433870 | 95.10 | 0.5373 | 117.583 | 906.356 |
| 2 | 199.56924 | 1.00000 | | | | 116.786 | |
| 3 | 189.29688 | 3.00000 | 1.804000 | 46.57 | 0.5572 | 116.005 | −247.991 |
| 4 | 96.65642 | 1.07300 | | | | 109.451 | |
| 5 | 95.95230 | 18.78274 | 1.433870 | 95.10 | 0.5373 | 109.405 | 236.880 |
| 6 | 1313.32305 | 11.15000 | | | | 108.221 | |
| 7 | 136.68838 | 8.72199 | 1.433870 | 95.10 | 0.5373 | 100.636 | 465.603 |
| 8 | 412.37152 | 0.20000 | | | | 99.933 | |
| 9 | 311.26943 | 4.86909 | 1.433870 | 95.10 | 0.5373 | 99.513 | 1000.056 |
| 10 | 1089.24099 | 0.20000 | | | | 98.818 | |
| 11 | 121.32814 | 7.75732 | 1.433870 | 95.10 | 0.5373 | 94.754 | 469.565 |
| 12 | 293.07570 | (Variable) | | | | 93.660 | |
| 13 | 58.30507 | 1.00000 | 2.000690 | 25.46 | 0.6133 | 33.063 | −36.566 |
| 14 | 22.41453 | 11.31524 | | | | 28.727 | |
| 15 | −24.84358 | 0.90000 | 1.882997 | 40.76 | 0.5667 | 27.351 | −35.308 |
| 16 | −121.61849 | 0.70000 | | | | 28.611 | |
| 17 | 110.69969 | 6.30923 | 1.922860 | 18.90 | 0.6495 | 29.529 | 37.135 |
| 18 | −49.14178 | (Variable) | | | | 29.687 | |
| 19 | −98.78852 | 1.10000 | 1.772499 | 49.60 | 0.5520 | 28.773 | −66.913 |
| 20 | 110.05178 | (Variable) | | | | 28.297 | |
| 21 | −51.04264 | 1.30000 | 1.717004 | 47.92 | 0.5605 | 28.239 | −37.278 |
| 22 | 57.30301 | 3.13167 | 1.846490 | 23.90 | 0.6217 | 30.027 | 84.539 |
| 23 | 269.78672 | (Variable) | | | | 30.448 | |
| 24 | 731.92415 | 4.50368 | 1.607379 | 56.81 | 0.5483 | 37.060 | 151.350 |
| 25 | −105.38942 | 0.15000 | | | | 37.977 | |
| 26 | 126.33215 | 3.53077 | 1.518229 | 58.90 | 0.5457 | 39.189 | 175.768 |
| 27 | −328.12184 | (Variable) | | | | 39.360 | |
| 28 | ∞ | 1.00000 | | | | 39.553 | |
| 29 | 291.14930 | 9.43204 | 1.487490 | 70.23 | 0.5300 | 39.756 | 71.018 |
| 30 | −39.02500 | 1.50000 | 1.834000 | 37.17 | 0.5774 | 39.875 | −190.462 |
| 31 | −52.53418 | 0.15000 | | | | 40.595 | |
| 32 | 47.98935 | 8.30910 | 1.487490 | 70.23 | 0.5300 | 38.562 | 57.493 |
| 33 | −64.06914 | 1.50000 | 1.882997 | 40.76 | 0.5667 | 37.940 | −47.596 |
| 34 | 125.61994 | 50.00000 | | | | 36.767 | |
| 35 | 114.54698 | 4.64093 | 1.517417 | 52.43 | 0.5564 | 30.568 | 141.126 |
| 36 | −201.14117 | 2.54355 | | | | 30.036 | |
| 37 | 65.92120 | 1.20000 | 1.785896 | 44.20 | 0.5631 | 28.417 | −85.491 |
| 38 | 33.09437 | 6.49533 | 1.517417 | 52.43 | 0.5564 | 27.399 | 38.823 |
| 39 | −48.23466 | 2.01000 | | | | 26.914 | |
| 40 | −99.31102 | 5.44373 | 1.517417 | 52.43 | 0.5564 | 24.165 | 74.992 |
| 41 | −28.51659 | 1.20000 | 1.834807 | 42.71 | 0.5642 | 22.459 | −31.739 |
| 42 | 413.36921 | 0.66799 | | | | 21.750 | |
| 43 | 40.59485 | 4.04093 | 1.487490 | 70.23 | 0.5300 | 21.242 | 126.119 |
| 44 | 114.83011 | 3.80000 | | | | 20.569 | |
| 45 | ∞ | 34.37500 | 1.608590 | 46.44 | 0.5664 | 31.250 | |
| 46 | ∞ | 13.75000 | 1.516800 | 64.17 | 0.5347 | 31.250 | |
| 47 | ∞ | 0.00000 | | | | 31.250 | |

Various data
Zoom ratio 40.00

| | Wide angle | Middle | Telephoto |
|---|---|---|---|
| Focal length | 11.00 | 69.58 | 440.00 |
| F number | 2.10 | 2.10 | 4.10 |
| Half angle of view | 26.57 | 4.52 | 0.72 |
| Image height | 5.50 | 5.50 | 5.50 |
| Total lens length | 400.14 | 400.14 | 400.14 |
| BF | 7.00 | 7.00 | 7.00 |
| d12 | 0.70 | 85.48 | 112.17 |
| d18 | 0.48 | 9.14 | 0.98 |
| d20 | 129.42 | 26.37 | 28.19 |
| d23 | 10.04 | 21.97 | 1.80 |
| d27 | 3.50 | 1.19 | 1.00 |
| d47 | 7.00 | 7.00 | 7.00 |
| Entrance pupil position | 91.53 | 674.07 | 3135.55 |
| Exit pupil position | −293.48 | −293.48 | −293.48 |
| Front principal point | 102.13 | 727.54 | 2931.25 |
| position | | | |
| Rear principal point | −4.00 | −62.58 | −433.00 |
| position | | | |

Zoom lens unit data

| | Leading | Focal | Lens configuration | Front principal point | Rear principal point |
|---|---|---|---|---|---|
| Unit | surface | length | length | position | position |
| 1 | 1 | 161.84 | 63.00 | 26.96 | −22.54 |
| 2 | 13 | −43.60 | 20.22 | −4.06 | −24.07 |
| 3 | 19 | −66.91 | 1.10 | 0.29 | −0.33 |
| 4 | 21 | −66.60 | 4.43 | 0.40 | −2.03 |
| 5 | 24 | 81.61 | 8.18 | 2.98 | −23.0 |
| 6 | 28 | 74.73 | 152.06 | 54.70 | −89.43 |

Single lens data

| Lens | Leading surface | Focal length |
|---|---|---|
| 1 | 1 | 906.36 |
| 2 | 3 | −247.99 |
| 3 | 5 | 236.88 |
| 4 | 7 | 465.60 |
| 5 | 9 | 1000.06 |
| 6 | 11 | 469.57 |
| 7 | 13 | −36.57 |
| 8 | 15 | −35.31 |
| 9 | 17 | 37.14 |
| 10 | 19 | −66.91 |
| 11 | 21 | −37.28 |
| 12 | 22 | 84.54 |
| 13 | 24 | 151.35 |
| 14 | 26 | 175.77 |
| 15 | 29 | 71.02 |
| 16 | 30 | −190.46 |
| 17 | 32 | 57.49 |
| 18 | 33 | −47.60 |
| 19 | 35 | 141.13 |
| 20 | 37 | −85.49 |
| 21 | 38 | 38.82 |
| 22 | 40 | 74.99 |
| 23 | 41 | −31.74 |
| 24 | 43 | 126.12 |
| 25 | 45 | |
| 26 | 46 | |

### Numerical Embodiment 5

Unit mm
Surface data

| Surface | | | | | | Effective | Focal |
|---|---|---|---|---|---|---|---|
| number i | ri | di | ndi | vdi | θgFi | diameter | length |
| 1 | 131.89273 | 6.37363 | 1.433870 | 95.10 | 0.5373 | 117.512 | 884.796 |
| 2 | 197.72254 | 1.00000 | | | | 116.708 | |
| 3 | 187.56918 | 3.00000 | 1.816000 | 46.62 | 0.5568 | 115.920 | −247.992 |
| 4 | 96.87752 | 1.07300 | | | | 109.392 | |
| 5 | 96.25984 | 18.75418 | 1.433870 | 95.10 | 0.5373 | 109.339 | 236.775 |
| 6 | 1386.50807 | 11.15000 | | | | 108.150 | |
| 7 | 135.72353 | 7.39036 | 1.433870 | 95.10 | 0.5373 | 100.489 | 586.041 |
| 8 | 285.49472 | 0.20000 | | | | 99.785 | |
| 9 | 233.53768 | 6.20429 | 1.433870 | 95.10 | 0.5373 | 99.416 | 684.621 |
| 10 | 1073.75429 | 0.20000 | | | | 98.714 | |
| 11 | 122.66344 | 7.65578 | 1.433870 | 95.10 | 0.5373 | 94.674 | 478.488 |
| 12 | 293.07570 | (Variable) | | | | 93.568 | |
| 13 | 66.75163 | 1.00000 | 2.000690 | 25.46 | 0.6133 | 34.240 | −38.193 |
| 14 | 24.26271 | 11.50930 | | | | 29.904 | |
| 15 | −25.64238 | 0.90000 | 1.882997 | 40.76 | 0.5667 | 28.456 | −41.416 |
| 16 | −86.06041 | 0.70000 | | | | 29.645 | |
| 17 | 144.31474 | 6.46147 | 1.922860 | 18.90 | 0.6495 | 30.374 | 37.445 |
| 18 | −45.18018 | 0.48366 | | | | 30.467 | |
| 19 | −87.69877 | 1.10000 | 1.772499 | 49.60 | 0.5520 | 29.161 | −52.021 |
| 20 | 75.24507 | (Variable) | | | | 28.389 | |
| 21 | −54.09102 | 1.30000 | 1.717004 | 47.92 | 0.5605 | 27.970 | −37.685 |
| 22 | 55.07687 | 3.05060 | 1.846490 | 23.90 | 0.6217 | 29.628 | 86.344 |
| 23 | 211.47936 | (Variable) | | | | 30.022 | |
| 24 | 328.70349 | 3.42086 | 1.607379 | 56.81 | 0.5483 | 37.141 | 215.706 |
| 25 | −218.50217 | 0.15000 | | | | 37.834 | |
| 26 | 112.27618 | 4.26968 | 1.518229 | 58.90 | 0.5457 | 38.995 | 296.377 |
| 27 | 407.49715 | (Variable) | | | | 39.464 | |
| 28 | ∞ | 1.00000 | | | | 39.612 | |
| 29 | 163.01054 | 9.43204 | 1.487490 | 70.23 | 0.5300 | 40.259 | 61.086 |
| 30 | −35.89070 | 1.50000 | 1.834000 | 37.17 | 0.5774 | 40.469 | −180.299 |
| 31 | −47.94674 | 0.15000 | | | | 41.484 | |
| 32 | 72.01768 | 8.30910 | 1.487490 | 70.23 | 0.5300 | 40.112 | 61.893 |
| 33 | −50.25206 | 1.50000 | 1.882997 | 40.76 | 0.5667 | 39.688 | −60.779 |
| 34 | −737.80496 | 50.00000 | | | | 39.418 | |
| 35 | 66.05279 | 4.64093 | 1.517417 | 52.43 | 0.5564 | 31.919 | 148.393 |
| 36 | 448.87983 | 2.54355 | | | | 31.141 | |
| 37 | 83.61369 | 1.20000 | 1.785896 | 44.20 | 0.5631 | 29.816 | −89.262 |
| 38 | 38.01535 | 6.49533 | 1.517417 | 52.43 | 0.5564 | 28.832 | 41.578 |
| 39 | −47.15253 | 2.01000 | | | | 28.411 | |
| 40 | −99.41582 | 5.44373 | 1.517417 | 52.43 | 0.5564 | 25.441 | 71.858 |
| 41 | −27.65806 | 1.20000 | 1.834807 | 42.71 | 0.5642 | 23.866 | −31.421 |
| 42 | 580.49114 | 0.66799 | | | | 23.155 | |
| 43 | 49.30343 | 4.04093 | 1.501270 | 56.50 | 0.5536 | 22.608 | 118.529 |
| 44 | 276.10611 | 3.80000 | | | | 21.573 | |
| 45 | ∞ | 34.37500 | 1.608590 | 46.44 | 0.5664 | 31.250 | |
| 46 | ∞ | 13.75000 | 1.516800 | 64.17 | 0.5347 | 31.250 | |
| 47 | ∞ | 0.00000 | | | | 31.250 | |

Various data
Zoom ratio 40.00

| | Wide angle | Middle | Telephoto |
|---|---|---|---|
| Focal length | 11.00 | 69.58 | 440.00 |
| F number | 2.10 | 2.10 | 4.10 |
| Half angle of view | 26.57 | 4.52 | 0.72 |
| Image height | 5.50 | 5.50 | 5.50 |
| Total lens length | 403.26 | 403.26 | 403.26 |
| BF | 10.00 | 10.00 | 10.00 |
| d12 | 0.97 | 85.81 | 111.56 |
| d20 | 129.35 | 35.23 | 28.64 |
| d23 | 10.04 | 20.40 | 1.78 |
| d27 | 3.50 | 2.41 | 1.87 |
| d47 | 10.00 | 10.00 | 10.00 |
| Entrance pupil position | 93.27 | 672.83 | 3155.82 |
| Exit pupil position | −257.62 | −257.62 | −257.62 |
| Front principal point | 103.82 | 724.32 | 2872.40 |
| position | | | |
| Rear principal point | −1.00 | −59.58 | −430.00 |
| position | | | |

Zoom lens unit data

| | | | Lens | Front | Rear |
|---|---|---|---|---|---|
| | Leading | Focal | configuration | principal point | principal point |
| Unit | surface | length | length | position | position |
| 1 | 1 | 161.84 | 63.00 | 26.76 | −22.74 |
| 2 | 13 | −21.52 | 22.15 | 4.50 | −11.97 |
| 3 | 21 | −66.60 | 4.35 | 0.52 | −1.86 |
| 4 | 24 | 124.83 | 7.84 | 1.25 | −3.82 |
| 5 | 28 | 67.44 | 152.06 | 47.19 | −100.49 |

Single lens data

| Lens | Leading surface | Focal length |
|---|---|---|
| 1 | 1 | 884.80 |
| 2 | 3 | −247.99 |
| 3 | 5 | 236.77 |
| 4 | 7 | 586.04 |
| 5 | 9 | 684.62 |
| 6 | 11 | 478.49 |
| 7 | 13 | −38.19 |
| 8 | 15 | −41.42 |
| 9 | 17 | 37.44 |
| 10 | 19 | −52.02 |
| 11 | 21 | −37.68 |
| 12 | 22 | 86.34 |
| 13 | 24 | 215.71 |
| 14 | 26 | 296.38 |
| 15 | 29 | 61.09 |
| 16 | 30 | −180.30 |
| 17 | 32 | 61.89 |
| 18 | 33 | −60.78 |
| 19 | 35 | 148.39 |
| 20 | 37 | −89.26 |
| 21 | 38 | 41.58 |
| 22 | 40 | 71.86 |
| 23 | 41 | −31.42 |
| 24 | 43 | 118.53 |
| 25 | 45 | |
| 26 | 46 | |

### Numerical Embodiment 6

Unit mm
Surface data

| Surface | | | | | | Effective | Focal |
|---|---|---|---|---|---|---|---|
| number i | ri | di | ndi | vdi | θgFi | diameter | length |
| 1 | −25110.14280 | 6.00000 | 1.834807 | 42.73 | 0.5648 | 203.582 | −384.675 |
| 2 | 327.15837 | 1.59003 | | | | 196.726 | |
| 3 | 321.68109 | 32.56730 | 1.433870 | 95.10 | 0.5373 | 196.600 | 421.518 |
| 4 | −413.25245 | 32.25814 | | | | 195.291 | |
| 5 | 337.42453 | 16.36645 | 1.433870 | 95.10 | 0.5373 | 195.265 | 844.528 |
| 6 | 4082.93537 | 0.25000 | | | | 194.793 | |
| 7 | 258.04199 | 22.27056 | 1.433870 | 95.10 | 0.5373 | 191.328 | 582.698 |
| 8 | −13870.84436 | 1.20000 | | | | 189.995 | |
| 9 | 165.53266 | 15.30800 | 1.433870 | 95.10 | 0.5373 | 175.221 | 819.559 |
| 10 | 300.37387 | (Variable) | | | | 173.007 | |
| 11 | 572.85560 | 2.35000 | 1.882997 | 40.76 | 0.5667 | 50.043 | −51.767 |
| 12 | 42.47898 | 18.65241 | | | | 43.343 | |
| 13 | −34.32253 | 1.45000 | 1.772499 | 49.60 | 0.5520 | 39.087 | −63.653 |
| 14 | −114.48795 | 7.69984 | 1.808095 | 22.76 | 0.6307 | 41.807 | 71.425 |
| 15 | −39.80319 | 0.19709 | | | | 43.607 | |
| 16 | −58.21530 | 2.00000 | 1.696797 | 55.53 | 0.5434 | 43.680 | −91.477 |
| 17 | −651.73077 | (Variable) | | | | 45.694 | |
| 18 | 517.79308 | 7.28014 | 1.603112 | 60.64 | 0.5415 | 80.813 | 285.620 |
| 19 | −258.28628 | 1.00500 | | | | 81.995 | |
| 20 | 138.30845 | 20.76855 | 1.438750 | 94.93 | 0.5340 | 86.072 | 149.814 |
| 21 | −120.09002 | 9.59366 | | | | 86.322 | |
| 22 | 170.24037 | 2.50000 | 1.717362 | 29.52 | 0.6047 | 79.879 | −156.766 |
| 23 | 67.62775 | 8.82607 | 1.438750 | 94.93 | 0.5340 | 76.353 | 359.235 |
| 24 | 113.51550 | (Variable) | | | | 75.695 | |
| 25 | 294.14761 | 14.10652 | 1.593490 | 67.00 | 0.5361 | 77.245 | 147.839 |
| 26 | −123.42655 | (Variable) | | | | 76.840 | |
| 27 | ∞ | 4.92616 | | | | 33.372 | |
| 28 | −69.17507 | 1.80000 | 1.816000 | 46.62 | 0.5568 | 31.665 | −39.799 |
| 29 | 62.53126 | 5.11643 | 1.808095 | 22.76 | 0.6307 | 31.262 | 58.913 |
| 30 | −200.73400 | 7.41605 | | | | 31.083 | |
| 31 | −28.94191 | 1.49977 | 1.816000 | 46.62 | 0.5568 | 30.102 | −25.444 |
| 32 | 76.55422 | 9.97320 | 1.548141 | 45.79 | 0.5686 | 33.098 | 38.975 |
| 33 | −28.46614 | 15.63678 | | | | 34.429 | |
| 34 | 162.87792 | 9.19327 | 1.531717 | 48.84 | 0.5631 | 36.429 | 65.718 |
| 35 | −43.88345 | 1.78139 | | | | 36.342 | |
| 36 | −90.37000 | 1.50000 | 1.882997 | 40.76 | 0.5667 | 33.978 | −33.943 |
| 37 | 45.59080 | 8.60872 | 1.518229 | 58.90 | 0.5457 | 33.317 | 43.578 |
| 38 | −42.19588 | 0.59328 | | | | 33.433 | |
| 39 | 170.24410 | 6.58015 | 1.496999 | 81.54 | 0.5375 | 31.604 | 56.333 |
| 40 | −33.19308 | 1.50000 | 1.882997 | 40.76 | 0.5667 | 30.967 | −40.510 |
| 41 | −437.83142 | 0.56165 | | | | 30.865 | |
| 42 | 82.70616 | 5.72967 | 1.522494 | 59.84 | 0.5440 | 30.636 | 71.005 |
| 43 | −66.15100 | 10.00000 | | | | 30.136 | |
| 44 | ∞ | 33.00000 | 1.608590 | 46.44 | 0.5664 | 40.000 | |
| 45 | ∞ | 13.20000 | 1.516330 | 64.14 | 0.5353 | 40.000 | |
| 46 | ∞ | 0.00000 | | | | 50.000 | |

Aspherical surface data
Eleventh surface

| | | | |
|---|---|---|---|
| K = −5.06977e+002 | A 4 = 8.85363e−007 | A 6 = −2.49171e−010 | A 8 = 2.80963e−014 |

Eighteenth surface

| | | | |
|---|---|---|---|
| K = −7.54553e−001 | A 4 = −3.41767e−007 | A 6 = −4.00004e−012 | A 8 = −4.18689e−015 |

Various data
Zoom ratio 79.99

| | Wide angle | Middle | Telephoto |
|---|---|---|---|
| Focal length | 10.00 | 89.44 | 799.90 |
| F number | 1.80 | 1.80 | 4.20 |
| Half angle of view | 28.81 | 3.52 | 0.39 |
| Image height | 5.50 | 5.50 | 5.50 |
| Total lens length | 725.60 | 725.60 | 725.60 |
| BF | 11.72 | 11.72 | 11.72 |
| d10 | 2.94 | 142.63 | 180.77 |
| d17 | 325.65 | 138.28 | 2.78 |
| d24 | 12.28 | 30.65 | 67.33 |
| d26 | 10.14 | 39.46 | 100.14 |
| d46 | 11.72 | 11.72 | 11.72 |
| Entrance pupil position | 147.70 | 1072.75 | 11741.95 |
| Exit pupil position | −24235.14 | −24235.14 | −24235.14 |
| Front principal point | 157.70 | 1161.86 | 12515.46 |
| position | | | |
| Rear principal point | 1.72 | −77.71 | −788.18 |
| position | | | |

Zoom lens unit data

| | | | Lens | Front | Rear |
|---|---|---|---|---|---|
| | Leading | Focal | configuration | principal point | principal point |
| Unit | surface | length | length | position | position |
| 1 | 1 | 246.00 | 127.81 | 74.83 | −19.86 |
| 2 | 11 | −28.50 | 32.35 | 6.49 | −18.82 |
| 3 | 18 | 137.46 | 49.97 | −5.27 | −38.64 |
| 4 | 25 | 147.84 | 14.11 | 6.31 | −2.65 |
| 5 | 27 | 61.57 | 138.62 | 61.41 | 9.03 |

Single lens data

| Lens | Leading surface | Focal length |
|---|---|---|
| 1 | 1 | −384.67 |
| 2 | 3 | 421.52 |
| 3 | 5 | 844.53 |
| 4 | 7 | 582.70 |
| 5 | 9 | 819.56 |
| 6 | 11 | −51.77 |
| 7 | 13 | −63.65 |
| 8 | 14 | 71.43 |
| 9 | 16 | −91.48 |
| 10 | 18 | 285.62 |
| 11 | 20 | 149.81 |
| 12 | 22 | −156.77 |
| 13 | 23 | 359.23 |
| 14 | 25 | 147.84 |
| 15 | 28 | −39.80 |
| 16 | 29 | 58.91 |
| 17 | 31 | −25.44 |
| 18 | 32 | 38.98 |
| 19 | 34 | 65.72 |
| 20 | 36 | −33.94 |
| 21 | 37 | 43.58 |
| 22 | 39 | 56.33 |
| 23 | 40 | −40.51 |
| 24 | 42 | 71.00 |
| 25 | 44 | |
| 26 | 45 | |

### Numerical Embodiment 7

Unit mm
Surface data

| Surface | | | | | | Effective | Focal |
|---|---|---|---|---|---|---|---|
| number i | ri | di | ndi | vdi | θgFi | diameter | length |
| 1 | −462.31573 | 2.20000 | 1.882997 | 40.76 | 0.5667 | 90.027 | −99.360 |
| 2 | 109.30856 | 3.35229 | | | | 84.667 | |
| 3 | 134.13128 | 16.02660 | 1.433870 | 95.10 | 0.5373 | 84.615 | 158.763 |
| 4 | −137.17894 | 9.04050 | | | | 84.045 | |
| 5 | 150.39507 | 9.19607 | 1.433870 | 95.10 | 0.5373 | 76.162 | 217.082 |
| 6 | −249.00153 | 0.15000 | | | | 75.319 | |
| 7 | 85.12758 | 8.06231 | 1.433870 | 95.10 | 0.5373 | 65.103 | 190.346 |
| 8 | −2931.92466 | 0.15000 | | | | 64.216 | |
| 9 | 51.61386 | 7.85260 | 1.433870 | 95.10 | 0.5373 | 56.925 | 151.459 |
| 10 | 227.37570 | (Variable) | | | | 56.124 | |
| 11 | −310.32731 | 0.90000 | 2.003300 | 28.27 | 0.5980 | 21.898 | −14.674 |
| 12 | 15.61403 | 4.60329 | | | | 18.399 | |
| 13 | −41.15275 | 5.79711 | 1.922860 | 18.90 | 0.6495 | 18.204 | 21.411 |
| 14 | −14.37680 | 0.70000 | 1.882997 | 40.76 | 0.5667 | 18.379 | −13.868 |
| 15 | 87.92415 | 0.20000 | | | | 18.453 | |
| 16 | 30.36409 | 3.06348 | 1.666800 | 33.05 | 0.5957 | 18.716 | 46.956 |
| 17 | 784.99832 | (Variable) | | | | 18.504 | |
| 18 | −41.83358 | 0.70000 | 1.756998 | 47.82 | 0.5565 | 18.798 | −21.101 |
| 19 | 26.23641 | 2.75535 | 1.846490 | 23.90 | 0.6217 | 20.059 | 48.795 |
| 20 | 67.29618 | (Variable) | | | | 20.482 | |
| 21 | −183.99508 | 4.04673 | 1.638539 | 55.38 | 0.5484 | 23.483 | 47.183 |
| 22 | −26.20784 | 0.15000 | | | | 24.273 | |
| 23 | −230.48273 | 2.46359 | 1.516330 | 64.14 | 0.5353 | 24.977 | 157.695 |
| 24 | −60.55272 | (Variable) | | | | 25.276 | |
| 25 | ∞ | 1.30000 | | | | 25.479 | |
| 26 | 32.16093 | 6.87396 | 1.517417 | 52.43 | 0.5564 | 25.836 | 35.421 |
| 27 | −39.91453 | 0.90000 | 1.834807 | 42.71 | 0.5642 | 25.339 | −35.813 |
| 28 | 123.06847 | 32.40000 | | | | 25.068 | |
| 29 | 66.78446 | 5.69362 | 1.496999 | 81.54 | 0.5375 | 26.152 | 55.622 |
| 30 | −46.06015 | 2.22280 | | | | 25.871 | |
| 31 | 200.96524 | 1.40000 | 1.834030 | 37.20 | 0.5775 | 24.243 | −25.397 |
| 32 | 19.21121 | 5.63992 | 1.487490 | 70.23 | 0.5300 | 23.274 | 47.224 |
| 33 | 103.12642 | 1.93515 | | | | 23.532 | |
| 34 | 1557.71280 | 7.31033 | 1.501270 | 56.50 | 0.5536 | 23.895 | 33.202 |
| 35 | −16.86785 | 1.40000 | 1.834807 | 42.71 | 0.5642 | 24.271 | −34.757 |
| 36 | −41.49741 | 0.14985 | | | | 26.400 | |
| 37 | 104.48429 | 6.21013 | 1.501270 | 56.50 | 0.5536 | 27.470 | 45.563 |
| 38 | −28.80137 | 4.00000 | | | | 27.695 | |
| 39 | ∞ | 33.00000 | 1.608590 | 46.44 | 0.5664 | 40.000 | |
| 40 | ∞ | 13.20000 | 1.516330 | 64.14 | 0.5353 | 40.000 | |
| 41 | ∞ | 0.00000 | | | | 40.000 | |

Various data
Zoom ratio 17.00

| | Wide angle | Middle | Telephoto |
|---|---|---|---|
| Focal length | 8.00 | 33.07 | 136.00 |
| F number | 1.91 | 1.94 | 2.50 |
| Half angle of view | 34.51 | 9.44 | 2.32 |
| Image height | 5.50 | 5.50 | 5.50 |
| Total lens length | 270.34 | 270.34 | 270.34 |
| BF | 7.49 | 7.49 | 7.49 |
| d10 | 1.05 | 33.34 | 48.74 |
| d17 | 51.11 | 6.20 | 3.09 |
| d20 | 4.70 | 10.23 | 2.88 |
| d24 | 0.95 | 8.03 | 3.09 |
| d41 | 7.49 | 7.49 | 7.49 |
| Entrance pupil position | 51.60 | 164.87 | 543.25 |
| Exit pupil position | 196.81 | 196.81 | 196.81 |
| Front principal point | 59.94 | 203.72 | 776.95 |
| position | | | |
| Rear principal point | −0.51 | −25.58 | −128.51 |
| position | | | |

Zoom lens unit data

| | | | Lens | Front | Rear |
|---|---|---|---|---|---|
| | Leading | Focal | configuration | principal point | principal point |
| Unit | surface | length | length | position | position |
| 1 | 1 | 65.01 | 56.03 | 35.83 | −0.11 |
| 2 | 11 | −13.49 | 15.26 | 0.20 | −10.77 |
| 3 | 18 | −36.17 | 3.46 | 0.81 | −1.04 |
| 4 | 21 | 36.66 | 6.66 | 3.30 | −0.93 |
| 5 | 25 | 51.48 | 123.64 | 65.08 | −49.62 |

Single lens data

| Lens | Leading surface | Focal length |
|---|---|---|
| 1 | 1 | −99.36 |
| 2 | 3 | 158.76 |
| 3 | 5 | 217.08 |
| 4 | 7 | 190.35 |
| 5 | 9 | 151.46 |
| 6 | 11 | −14.67 |
| 7 | 13 | 21.41 |
| 8 | 14 | −13.87 |
| 9 | 16 | 46.96 |
| 10 | 18 | −21.10 |
| 11 | 19 | 48.80 |
| 12 | 21 | 47.18 |
| 13 | 23 | 157.70 |
| 14 | 26 | 35.42 |
| 15 | 27 | −35.81 |
| 16 | 29 | 55.62 |
| 17 | 31 | −25.40 |
| 18 | 32 | 47.22 |
| 19 | 34 | 33.20 |
| 20 | 35 | −34.76 |
| 21 | 37 | 45.56 |
| 22 | 39 | |
| 23 | 40 | |

TABLE 1
Numerical values corresponding to each of conditional expressions in Numerical
Embodiments 1 to 7

| | | Numerical embodiment | | | | | | |
|---|---|---|---|---|---|---|---|---|
| Conditional expression | | 1 | 2 | 3 | 4 | 5 | 6 | 7 |
| (1) | νn | 40.78 | 40.78 | 42.71 | 46.57 | 46.62 | 42.73 | 40.76 |
| (2) | Nn + 0.01 × νn | 2.259 | 2.259 | 2.262 | 2.270 | 2.282 | 2.262 | 2.291 |
| (3) | Nn | 1.852 | 1.852 | 1.835 | 1.804 | 1.816 | 1.835 | 1.883 |
| (4) | \|fn/f1\| | 1.85 | 1.54 | 1.61 | 1.53 | 1.53 | 1.56 | 1.53 |
| (5) | vpa | 95.10 | 84.89 | 95.10 | 95.10 | 95.10 | 95.10 | 95.10 |
| (6) | (θp2 − θn2)/(νn2 − νp2) | 0.00550 | 0.00550 | 0.00487 | 0.00552 | 0.00552 | 0.00356 | 0.00550 |
| (7) | \|f1/f2\| | 7.22 | 6.01 | 3.22 | 3.71 | 7.52 | 8.63 | 4.82 |

### Embodiment 8

(Image Pickup Apparatus)

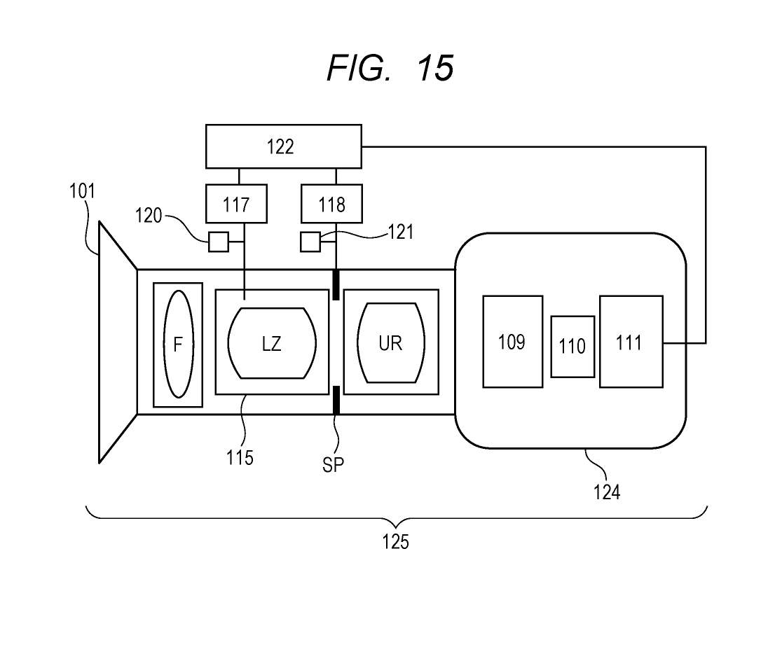

FIG. 15 illustrates a schematic view of an image pickup apparatus (television camera system) which uses the zoom lens of any one of Embodiments 1 to 7 as a photographing optical system. In FIG. 15, a zoom lens 101 is any one of zoom lenses in Embodiments 1 to 7. A camera 124 is shown. The zoom lens 101 is structured so as to be detachable from the camera 124. An image pickup apparatus 125 is structured by the camera 124 and the zoom lens 101 which is mounted thereon. The zoom lens 101 has a first lens unit F for focusing, a zooming lens unit LZ, and a relay lens unit UR for imaging. The zooming lens unit LZ includes a lens unit which moves for zooming. An aperture stop SP is illustrated. A driving mechanism 115 such as a helicoid and a cam drives the zooming lens unit LZ in the optical axis direction. Motors (driving unit) 117 and 118 electrically drive the driving mechanism 115 and the aperture stop SP. Detectors 120 and 121 such as an encoder, a potentiometer and a photosensor detect a position on the optical axis of the zooming lens unit LZ and an aperture diameter of the aperture stop SP. In the camera 124, a glass block 109 corresponds to an optical filter or a color separation optical system in the camera 124, and a solid-state image pickup element 110 (photoelectric conversion element) is a CCD sensor, a CMOS sensor or the like, and receives light of a subject image which has been formed by the zoom lens 101. Incidentally, when the electronic image pickup element is used, an output image can be further enhanced to a high image quality by an operation of electronically correcting the aberration. In addition, CPUs 111 and 122 control various drives of the camera 124 and the zoom lens 101.

Thus, when being applied to a digital video camera, a TV camera or a camera for cinema, the zoom lens according to the present invention achieves an image pickup apparatus having a high optical performance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-007596, filed Jan. 19, 2017 which is hereby incorporated by reference herein in its entirety.

What is claimed is:

1. A zoom lens comprising in order from an object side to an image side:
a first lens unit having a positive refractive power and configured not to move for zooming; a second lens unit having a negative refractive power and configured to move to the image side for zooming from a wide angle end to a telephoto end; and a relay lens unit configured not to move for zooming,
wherein the first lens unit consists of five lenses including, in order from the object side to the image side, a negative lens, a positive lens, a positive lens, a positive lens and a positive lens, or six lenses including, in order from the object side to the image side, a positive lens, a negative lens, a positive lens, a positive lens, a positive lens and a positive lens, and
conditional expressions
39<νn<48,
2.24<Nn+0.01×νn<2.32,
1.79<Nn<1.91, and
1.5<|fn/f1|<2.0
are satisfied, where Nn represents a refractive index of the negative lens in the first lens unit, νn represents an Abbe number of the negative lens, fn represents a focal length of the negative lens, and f1 represents a focal length of the first lens unit, the Abbe number ν being expressed by an expression
ν=(Nd−1)/(NF−NC)
where NF, Nd and NC represent refractive indices with respect to an F-line, a d-line and a C-line of Fraunhofer lines, respectively.

2. The zoom lens according to claim 1, wherein a conditional expression
77<νpa<100
is satisfied, where νpa represents an average of values of the Abbe number of the positive lenses in the first lens unit.

3. The zoom lens according to claim 1, wherein the zoom lens consists of, in order from the object side to the image side, the first lens unit, the second lens unit, a third lens unit configured to move for zooming, and the relay lens unit.

4. The zoom lens according to claim 1, wherein the zoom lens consists of, in order from the object side to the image side, the first lens unit, the second lens unit, a third lens unit configured to move for zooming, a fourth lens unit configured to move for zooming, and the relay lens unit.

5. The zoom lens according to claim 1, wherein the zoom lens consists of, in order from the object side to the image side, the first lens unit, the second lens unit, a third lens unit configured to move for zooming, a fourth lens unit configured to move for zooming, a fifth lens unit configured to move for zooming, and the relay lens unit.

6. The zoom lens according to claim 1, wherein a conditional expression
3.1×10⁻³<(θp2−θn2)/(νn2−νp2)<6.0×10⁻³,
is satisfied, where νp2 and θp2 respectively represent the Abbe number and a partial dispersion ratio of a positive lens having the Abbe number smallest of ones of the Abbe number of positive lenses included in the second lens unit, and νn2 and θn2 respectively represent the Abbe number and a partial dispersion ratio of a negative lens having the Abbe number smallest of ones of the Abbe number of negative lenses included in the second lens unit, the partial dispersion ratio θ being expressed by an expression
θ=(Ng−NF)/(NF−NC),
where Ng represents a refractive index with respect to a g-line of Fraunhofer lines.

7. The zoom lens according to claim 1, wherein a conditional expression
3<|f1/f2|<9
is satisfied, where f1 represents a focal length of the first lens unit, and f2 represents a focal length of the second lens unit.

8. An image pickup apparatus comprising:
a zoom lens comprising in order from an object side to an image side:
a first lens unit having a positive refractive power and configured not to move for zooming; a second lens unit having a negative refractive power and configured to move to the image side for zooming from a wide angle end to a telephoto end; and a relay lens unit configured not to move for zooming,
wherein the first lens unit consists of five lenses including, in order from the object side to the image side, a negative lens, a positive lens, a positive lens, a positive lens and a positive lens, or six lenses including, in order from the object side to the image side, a positive lens, a negative lens, a positive lens, a positive lens, a positive lens and a positive lens, and
conditional expressions
39<νn<48,
2.24<Nn+0.01×νn<2.32,
1.79<Nn<1.91, and
1.5<|fn/f1|<2.0
are satisfied, where Nn represents a refractive index of the negative lens in the first lens unit, νn represents an Abbe number of the negative lens, fn represents a focal length of the negative lens, and f1 represents a focal length of the first lens unit, the Abbe number ν being expressed by an expression
ν=(Nd−1)/(NF−NC)
where NF, Nd and NC represent refractive indices with respect to an F-line, a d-line and a C-line of Fraunhofer lines, respectively, and
an image pickup element configured to receive an image formed by the zoom lens.
